(19) United States
(12) Patent Application Publication
(10) Pub. No.: US 2022/0223845 A1
(43) Pub. Date: Jul. 14, 2022

(54) ELECTRODES FOR ALKALINE IRON BATTERIES

(71) Applicant: FORM ENERGY, INC., Somerville, MA (US)

(72) Inventors: Chenguang YANG, Louisville, CO (US); Lang J. MCHARDY, Louisville, CO (US); Annelise Christine THOMPSON, Medford, MA (US); Rupak CHAKRABORTY, Brookline, MA (US)

(21) Appl. No.: 17/574,158

(22) Filed: Jan. 12, 2022

Related U.S. Application Data
(60) Provisional application No. 63/136,746, filed on Jan. 13, 2021.

(51) Int. Cl. H01M 4/38

(52) U.S. Cl. CPC H01M 4/38; C01G 9/08

(57) ABSTRACT

Various embodiments may include a battery electrode, comprising: an iron electrode body comprising iron active material and a zinc sulfide additive, wherein the zinc sulfide additive comprises crystalline cubic zinc sulfide. Various embodiments may include a battery electrode, comprising: an iron electrode body comprising iron active material and a manganese sulfide additive, wherein the manganese sulfide additive comprises crystalline cubic manganese sulfide. Various embodiments may include an iron electrode battery, comprising: an iron electrode; and a sulfide reservoir separate from the iron electrode, the sulfide reservoir comprising crystalline cubic zinc sulfide. Various embodiments may include an iron electrode battery, comprising: an iron electrode and a sulfide reservoir separate from the iron electrode, the sulfide reservoir comprising crystalline cubic manganese sulfide.

### RELATED APPLICATIONS

This application claims the benefit of priority to U.S. Provisional Patent Application No. 63/136,746 entitled “Electrodes for Alkaline Iron Batteries” filed Jan. 13, 2021, the entire contents of which are hereby incorporated by reference for all purposes. The present application is also related to subject matter disclosed in International Patent Publication No. WO2019133702, published Jul. 4, 2019 (hereinafter “Pham publication '702”), which is incorporated herein by reference in its entirety for all purposes to the extent not inconsistent with the disclosure herein.

### FIELD

This invention generally relates to battery electrodes and more particularly to battery electrodes with iron active material.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to days. The size of batteries range from backup power on order of watts to kilowatts for communications systems, to megawatt-scale for large electricity grids.

This Background section is intended to introduce various aspects of the art, which may be associated with embodiments of the present inventions. Thus, the foregoing discussion in this section provides a framework for better understanding the present inventions, and is not to be viewed as an admission of prior art.

### SUMMARY

Various embodiments of systems and methods are provided herein for making and using additives found to be particularly useful for enhancing the performance of iron-electrode batteries. The additives generally comprise zinc sulfide (also referred to herein by the chemical formula “ZnS”) and/or manganese sulfide (also referred to herein by the chemical formula “MnS”) substantially entirely in a particular crystal form.

Various embodiments may include a battery electrode, comprising: an iron electrode body comprising iron active material and a zinc sulfide additive, wherein the zinc sulfide additive comprises crystalline cubic zinc sulfide.

Various embodiments may include a battery electrode, comprising: an iron electrode body comprising iron active material and a manganese sulfide additive, wherein the manganese sulfide additive comprises crystalline cubic manganese sulfide.

Various embodiments may include an iron electrode battery, comprising: an iron electrode; and a sulfide reservoir separate from the iron electrode, the sulfide reservoir comprising crystalline cubic zinc sulfide.

Various embodiments may include an iron electrode battery, comprising: an iron electrode and a sulfide reservoir separate from the iron electrode, the sulfide reservoir comprising crystalline cubic manganese sulfide.

### BRIEF DESCRIPTION OF THE DRAWINGS

The novel features of the invention are set forth with particularity in the claims that follow. A better understanding of the features and advantages of the present invention will be obtained by reference to the following detailed description that sets forth illustrative embodiments, in which the principles of the invention are utilized, and the accompanying drawings.

FIG. 1A illustrates an example of an electrochemical cell that may be an iron-electrode battery according to aspects of various embodiments.

FIG. 1B illustrates an example of an electrochemical cell that may be an iron-electrode battery according to aspects of various embodiments.

FIG. 1C is a series of schematic charts illustrating changing sulfide concentration during a soak time for samples with various ratios of zinc sulfide solid to liquid electrolyte.

FIG. 2A is a schematic X-Ray Diffraction spectrum representing two sample iron electrodes containing an “unstructured” cubic zinc sulfide additive and a “crystalline” zinc sulfide additive.

FIG. 2B is a schematic chart illustrating an enlarged view of the XRD peak labelled 200 of FIG. 2A, showing the difference in full-width-half-maximum values of the peak for the two samples.

FIG. 3 is a schematic diagram illustrating a range of FWHM values for selected peak positions for samples of unstructured cubic ZnS and crystalline cubic ZnS.

FIGS. 4-12 illustrate various example systems in which one or more aspects of the various embodiments may be used as part of bulk energy storage systems.

### DETAILED DESCRIPTION

The various embodiments will be described in detail with reference to the accompanying drawings. References made to particular examples and implementations are for illustrative purposes, and are not intended to limit the scope of the invention or the claims. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories many not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this Specification. Thus, the scope of protection afforded the present inventions should not be limited to a particular embodiment, configuration or arrangement that is set forth in a particular embodiment, example, or in an embodiment in a particular figure.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Various embodiments of systems and methods are provided herein for making and using additives found to be particularly useful for enhancing the performance of iron-electrode batteries. The additives generally comprise zinc sulfide (also referred to herein by the chemical formula “ZnS”) and/or manganese sulfide (also referred to herein by the chemical formula “MnS”) substantially entirely in a particular crystal form. As will be described in further detail below, crystalline cubic ZnS has been found to produce an order of magnitude lower concentration of dissolved sulfide in 6M KOH than other crystal forms of ZnS. This lower sulfide concentration allows for long-term maintenance of an electrolyte sulfide concentration within an ideal range which has been found to prolong the life and enhance the performance of iron-electrode batteries. Various examples and embodiments of iron-electrode batteries containing ZnS substantially entirely in the form of crystalline cubic ZnS are also described herein. Crystalline cubic MnS is contemplated herein to produce similar results.

Without wishing to be bound by any particular theory, there may be discussion herein of beliefs or understandings of underlying principles relating to the devices and methods disclosed herein. Inventors recognize that regardless of the ultimate correctness of any mechanistic explanation or hypothesis, an embodiment of the invention can nonetheless be operative and useful.

As used herein, the term “iron electrode” refers to a porous or non-porous, rigid or flexible, electrically conductive structure containing iron active materials capable of participating in electrochemical reactions in an electrochemical device such as a primary or secondary battery, an electrolyzer, or other electrochemical cell. Iron electrodes may be fabricated by any available technique or combination of techniques, including sintering, hot-pressing, cold-pressing, wet-paste lamination, dry pressing, slurry coating, PTFE based process, roll bonding, tape casting (blade coating), pocket-filling, or other suitable process. In various embodiments, iron electrodes may also include additive materials, pore formers, binders, current collectors, support materials, conductivity-enhancing additives, or other materials.

As used herein, the term “iron active material” refers to an iron-containing material that is capable of undergoing oxidation reactions during discharging of the electrochemical cell, and/or reduction reactions during charging of the electrochemical cell. Specifically, iron active materials may include metallic iron (Fe) and/or one or more iron hydroxides (e.g., Fe(OH)₂, Fe(OH)₃, or others), anhydrous and/or hydrated iron oxyhydroxides (e.g., FeOOH; e.g., FeO(OH).nH₂O where n is a number of water molecules in a hydrated iron hydroxide molecule), iron oxides, sub-oxides, mixed oxides, including FeO (wustite), FeO₂ (iron dioxide), Fe₂O₃, Fe₃O₄ (magnetite), Fe₄O₅, Fe₅O₆, Fe₅O₇, Fe₂₅O₃₂, Fe₁₃O₁₉, other iron-containing compounds, any polymorph(s) of these, and/or any combinations of these.

As used herein, the term “iron-electrode battery” refers to a primary battery (single-use discharge-only) or a secondary (rechargeable) battery containing iron active material that undergoes oxidation and reduction in the negative polarity electrode of the battery. In some embodiments, an iron-electrode battery may contain iron active material as a majority component (i.e., more than 50% of the electrode active material is one or more iron active materials) of the negative-polarity electrode. Some example iron-electrode batteries include nickel-iron batteries (NiOOH—Fe), manganese-dioxide-iron batteries (MnO₂—Fe), iron-air batteries (Fe—O₂ batteries, which may include flow-batteries or hybrid battery/fuel-cell systems), silver-iron batteries (Ag—Fe), flow batteries such as all-iron flow batteries, or any other battery containing an electrode temporarily or permanently containing an iron active material. The term “manganese dioxide” is inclusive of the many manganese oxide phases known to function as battery cathodes, including gamma, delta, birnessite, or other manganese oxide phases, produced by chemical or electrolytic or other synthesis processes.

Embodiments of the present invention include apparatus, systems, and methods for long-duration, and ultra-long-duration, low-cost, energy storage. Herein, “long duration” and/or “ultra-long duration” may refer to periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. In other words, “long duration” and/or “ultra-long duration” energy storage cells may refer to electrochemical cells that may be configured to store energy over time spans of days, weeks, or seasons. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Other embodiments include backup power for telecommunications, data centers, electronic devices, transportation signals, medical facilities, or buildings. The duration of power delivery from the battery may range from a few minutes to a few hours. The durations of energy storage and/or power delivery described herein are provided merely as examples and are not intended to be limiting.

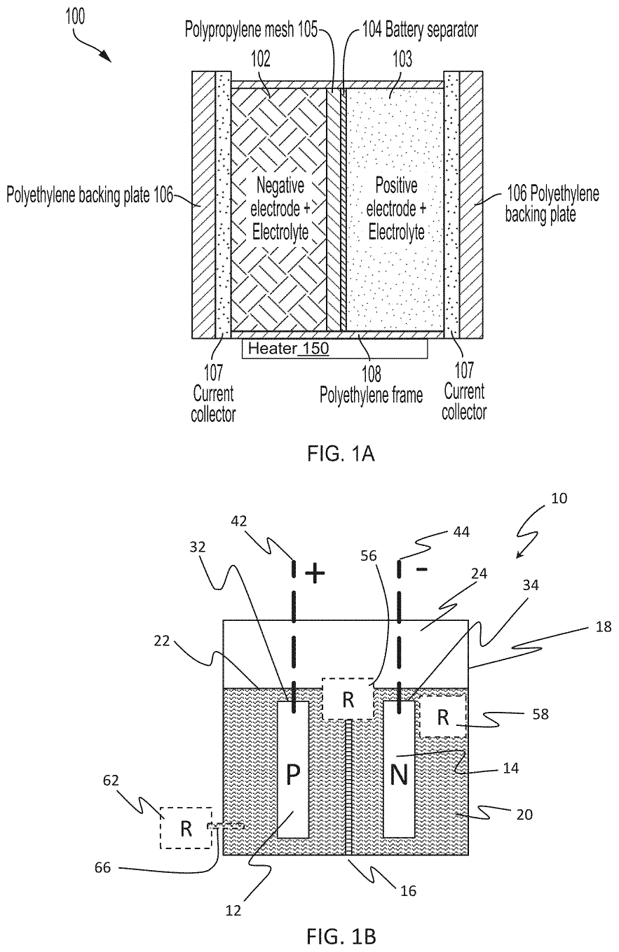

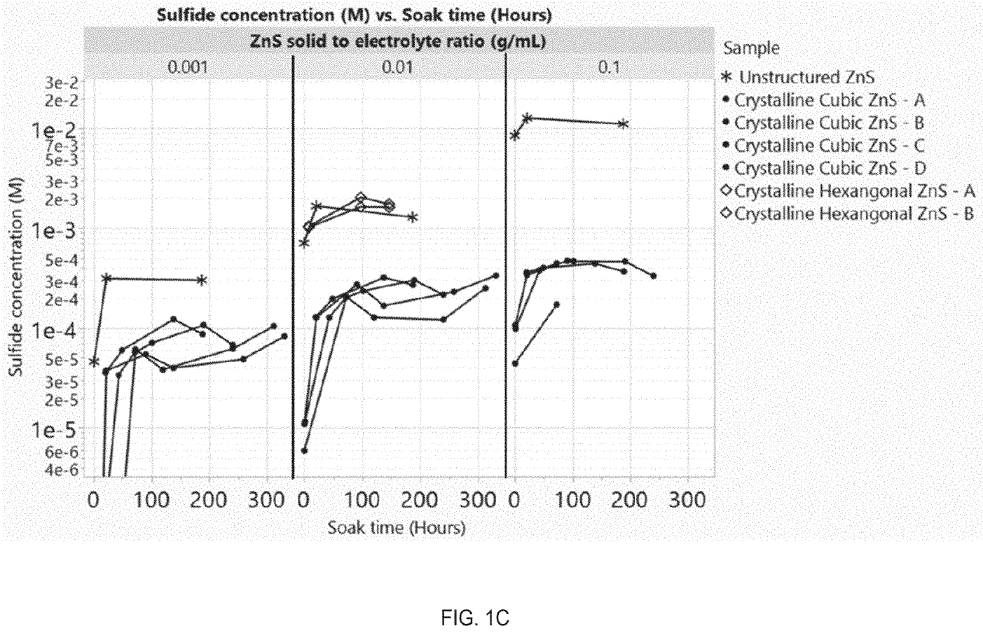

FIG. 1A illustrates an example of an electrochemical cell that may be an iron-electrode battery according to aspects of various embodiments. The electrochemical cell includes a negative electrode, a positive electrode, an electrolyte, and a separator disposed between the positive electrode and the negative electrode (for example as shown in FIG. 1A). FIG. 1A illustrates an example electrochemical cell 100, such as a battery, including a negative electrode and electrolyte 102 separated from a positive electrode and electrolyte 103 by a separator 104. The separator 104 optionally may be supported by a polypropylene mesh 105 and a polyethylene or polypropylene frame 108 of the cell 100. Current collectors 107 may be associated with respective ones of the negative electrode 102 and positive electrode 103 and supported by polyethylene or polypropylene backing plates 106. In some embodiments, the temperature of the electrochemical cell 100, may be controlled, such as by insulation around the cell 100 and/or a heater 150. For example, the heater 150 may raise the temperature of the cell 100 and/or specific components of the cell, such as the electrolyte 102, 103. The configuration of the electrochemical cell 100 in FIG. 1A is merely an example of one electrochemical cell configuration according to various embodiments and is not intended to be limiting. Other configurations, such as electrochemical cells with different type meshes and/or without the polypropylene mesh 105, electrochemical cells with different type frames and/or without the polyethylene frame 108, electrochemical cells with different type current collectors and/or without the current collectors, electrochemical cells with reservoir structures (e.g., reservoir structures such as any one or more of the various sulfide reservoirs discussed in Pham publication '702), electrochemical cells with different type backing plates and/or without the polyethylene backing plates 106, electrochemical cells with different type insulation and/or without insulation, and/or electrochemical cells with different type heaters and/or without a heater 150, may be substituted for the example configuration of the electrochemical cell 100 shown in FIG. 1A and other configurations are in accordance with the various embodiments.

In some embodiments, a plurality of electrochemical cells 100 in FIG. 1A may be connected electrically in series to form a stack. In certain other embodiments, a plurality of electrochemical cells 100 may be connected electrically in parallel. In certain other embodiments, the electrochemical cells 100 are connected in a mixed series-parallel electrical configuration to achieve a favorable combination of delivered current and voltage.

According to various embodiments, the negative electrode is comprised of iron-containing material. The iron-containing material may be pelletized, briquetted, pressed or sintered iron-bearing compounds. Such iron-bearing compounds may comprise one or more forms of iron, ranging from highly reduced (more metallic) iron to highly oxidized (more ionic) iron. In various embodiments, the pellets may include various iron compounds, such as iron oxides, hydroxides, sulfides, carbides, or combinations thereof. In various embodiments, said negative electrode may be sintered iron-containing material with various shapes. In some embodiments, atomized or sponge iron powders can be used as the feedstock material for forming sintered iron electrodes. In some embodiments, the green body may further contain a binder such as a polymer or inorganic clay-like material. In various embodiments, sintered iron-containing material pellets may be formed in a furnace, such as a continuous feed calcining furnace, batch feed calcining furnace, shaft furnace, rotary calciner, rotary hearth, etc. In various embodiments, pellets may comprise forms of reduced and/or sintered iron-bearing precursors known to those skilled in the art as direct reduced iron (DRI), and/or its byproduct materials.

According to various embodiments, an electrochemical cell, such as cell 100 of FIG. 1A, includes a negative electrode (also referred to as an anode), a positive electrode (also referred to as a cathode), and an electrolyte. The negative electrode may be an iron material. The electrolyte may be an aqueous solution. In certain embodiments the electrolyte may be an alkaline solution (pH>10). In certain embodiments, the electrolyte may be a near-neutral solution (10>pH>4).

FIG. 1B illustrates an example of an electrochemical cell that may be an iron-electrode battery according to aspects of various embodiments. FIG. 1B illustrates a secondary (rechargeable) battery system 10 comprising a positive electrode 12, a negative electrode 14, and a separator 16 within a battery container 18 filled with electrolyte 20 to a level 22 at least as high as the tops 32, 34 of the electrodes 12, 14. The space above the electrolyte level 22 may be referred to as the headspace 24. The positive electrode 12 may be electrically connected to the battery's positive terminal 42 and may contain active material that may undergo reduction reactions during discharging and oxidation reactions during charging. The negative electrode 14 may be electrically connected to the battery's negative terminal 44 and may contain active material that may undergo oxidation reactions during discharging and reduction reactions during charging of the battery 10. The configuration of the electrochemical cell in FIG. 1B is merely an example of one electrochemical cell configuration according to various embodiments and is not intended to be limiting.

The negative electrode 14 active material may include metal or metal oxides such as iron, zinc, cadmium, or other metals and/or oxides or hydroxides of these or other metals. In some embodiments, the iron negative electrode active material may include iron provided as elemental iron and/or as an iron-containing material, such as an iron-containing alloy or an iron-containing compound, such as an iron oxide, iron mixed oxide, iron hydroxide, iron sulphate, iron carbonate, iron sulfide, or any combination of these. In some embodiments, iron negative electrode active materials may include purified or refined iron materials such as carbonyl iron or electrolytic iron, or iron ores such as magnetite, maghemite, iron carbonate, hematite, goethite, limonite, or other iron materials.

In some embodiments, an iron negative electrode may contain carbonyl iron or other iron active material (e.g., magnetite, hematite, or other iron oxides or iron hydroxides) and two or more soluble metal sulfide additives in amounts from about 0.01 weight percent (as a percent of the weight of carbonyl iron) to 10 weight percent or more. For example, an iron negative electrode may contain an iron active material, an iron sulfide additive in an amount from about 0.01% to about 10% by weight of the iron active material, and a second sulfide compound (e.g., bismuth sulfide, iron sulfide, iron disulfide, iron-copper sulfide, zinc sulfide, manganese sulfide, tin sulfide, copper sulfide, cadmium sulfide, a sub-oxide of iron sulfide, silver sulfide, titanium disulfide, lead sulfide, molybdenum sulfide, nickel sulfide, antimony sulfide, dimethylsulfide, carbon disulfide, or others) in an amount from about 0.01% to about 10% by weight of the iron active material.

In various embodiments, the electrolyte 20 may be an aqueous or non-aqueous alkaline, neutral, or acidic solution. For example, the electrolyte solution may contain potassium hydroxide (KOH), sodium hydroxide (NaOH), lithium hydroxide (LiOH) or combinations of these.

In some embodiments, a battery 10 may include a separator 16 configured to allow transfer of ions between the electrodes 12, 14 via the electrolyte. In some embodiments, a separator may be chosen based on an ability to allow selective transfer of desired molecules or materials while substantially limiting or preventing transfer of undesired molecules or materials. For example, some separator membranes are ion-selective and allow the transfer of negative (or positive) ions while substantially preventing transfer of positive (or negative) ions. In other examples, separator materials may be chosen based on an ability to allow or prevent the cross-over of gas bubbles from one side (associated with one electrode) to the opposite side (associated with the counter-electrode).

In various embodiments, the battery container 18 may be made of any suitable materials and construction capable of containing the electrolyte, electrodes, and at least a minimum amount of gas pressure. For example, the battery container 18 may be made of metals, plastics, composite materials, or others. In some embodiments, the battery container 18 may be sealed so as to prevent the escape of any gases generated during operation of the battery.

In some embodiments, the battery container 18 may include a pressure relief valve to allow release of gases when a gas pressure within the battery container 18 exceeds a predetermined threshold.

While the electrodes 12, 14 are shown substantially spaced apart in the figures, in some embodiments the electrodes may be very close to one another or even compressed against one another with a separator 16 in between. Furthermore, although the figures may illustrate a single positive electrode 12 and a single negative electrode 14, battery systems within the scope of the present disclosure may also include two or more positive electrodes 12 and/or two or more negative electrodes 14.

FIG. 1B also illustrates multiple possible example positions for a sulfide reservoir (e.g., 58, 56, and/or 62) within or relative to the battery container. The example positions of the sulfide reservoir illustrated in FIG. 1B are merely example configurations according to various embodiments and are not intended to be limiting. The sulfide reservoirs 58, 56, and/or 62 may be any type reservoir structures, such as any one or more of the various sulfide reservoirs discussed in Pham publication '702.

In order to further extend the usable life of a nickel-iron battery requiring minimal maintenance, a long-term reservoir of soluble sulfide may be provided in the battery. As used herein, the term “sulfide reservoir” may refer to a source of sulfide ions other than an “additive sulfide” and an “incorporated sulfide,” both of which are located within and electrically connected to the iron negative electrode. “Reservoir sulfide” may be located outside of but electrically connected to the iron electrode, located inside of but electrically isolated from or disconnected from the iron electrode, or both located outside of and electrically disconnected from the iron electrode. Sulfide may generally be released from a sulfide reservoir into the electrolyte by chemical reactions, electrochemical reactions, phase change reactions, and/or controlled mechanical actions (e.g., movement of a servo, piston, relay, or other electromechanical devices), or combinations of these or other mechanisms.

In some embodiments, a closed-loop automatic control system may be configured to detect a condition or an event directly or indirectly suggesting a need for a sulfide addition to the electrolyte, and upon detecting the event or condition, delivering or releasing a quantity of a sulfide source from a sulfide reservoir into the electrolyte. For example, in some embodiments a sulfide detector (e.g., a sulfide ion-selective-electrode, an optical sulfide detector, or others) may be joined to an automatic controller configured to periodically or continuously detect a sulfide concentration in the electrolyte with the sulfide detector. In response to detecting a sulfide concentration below a threshold, the control system may activate an actuator device to deliver a sulfide-source material into the electrolyte. For example, the actuator may be a pump, syringe, or plunger configured to deliver a quantity of a solid or liquid sulfide-source material into the electrolyte, for example, which may be the same amount every time or a different amount.

In other embodiments, an automatic control system may be configured to detect one or more events that may be indicative of a need for sulfide in the electrode. For example, an electronic controller may be configured to monitor cell performance and to operate an actuator to deliver a sulfide-source material to the electrolyte in response to detecting low-sulfide event. Example low-sulfide events may include a drop in coulombic efficiency greater than a threshold change, a decrease in discharge rate capability greater than a threshold amount, a substantial period of over-charge (e.g., a fixed period of time, or a predetermined quantity of overcharge in coulombs), a change in electrolyte conductivity greater than a threshold amount, or other events.

In some embodiments, low-sulfide events may be “detected” chemically and/or electrochemically in such a way as to chemically or electrochemically trigger an automatic release of sulfide. In an embodiment, for example, the system is configured such that detection or characterization of a low-sulfide event is used as a triggering event resulting in an “automatic release” of sulfide, for example, using a active or passive system or method for releasing sulfide.

In various embodiments, an actuator may be configured to release or deliver a consistent quantity of sulfide each time the actuator is triggered, or the actuator may be configured to release or deliver a quantity of sulfide in proportion to a quantitative measure of a triggering event.

In some embodiments, a sulfide reservoir may be configured to release sulfide ions into the electrolyte at a slow rate in a location within the battery adjacent to the negative electrode such that a substantial portion of the released sulfide ions will reach the iron electrode to replace consumed sulfide. In some embodiments, a sulfide-source material for a sulfide reservoir may comprise one or more soluble metal sulfides such as iron sulfide (e.g., FeS, FeS₂, Fe₃S₄ or other iron sulfide compounds or combinations thereof), zinc sulfide, manganese sulfide, lead sulfide, nickel sulfide, tin sulfide, bismuth sulfide, copper sulfide (CuS, Cu₂S, or other copper sulfides), or cadmium sulfide, including any polymorphs of these, or combinations of these and/or other metal sulfides. In some embodiments, a sulfide-source material for a sulfide reservoir may include one or more sub-oxides of iron sulfide of the form FeSi₁₋ₓOₓ. In some embodiments, preferred materials for a sulfide reservoir may comprise sparingly soluble metal sulfides, that is metal sulfides that release no more than 10 milli-moles of sulfide ions per liter of electrolyte at temperatures up to 70° C.

In some embodiments, a sulfide reservoir may be configured to have a slow rate of release of sulfide from the reservoir into the electrolyte. The rate of release of sulfide from a sulfide reservoir may be a rate of dissolution if the reservoir is a solid sulfide source that releases sulfide by dissolution, a rate of electrochemical reduction if the reservoir is configured to release sulfide ions by electrochemical reaction (e.g., by electrochemical reduction of a solid sulfide source electrically connected to the negative electrode), a rate of injection or release of a liquid sulfide source, and/or a rate of release and/or dissolution of a gaseous sulfur source (e.g., SO₂ or H₂S).

A rate of dissolution of a solid sulfide reservoir in aqueous alkaline battery electrolyte may be a function of surface area of the sulfide reservoir exposed to the electrolyte, dissolution kinetics of a sulfide-source material, diffusion kinetics and/or dissolution kinetics of a barrier surrounding a sulfide-source material, a temperature of the electrolyte, a solubility limit (saturation limit) of the sulfide reservoir material, and a rate at which sulfide is removed from the electrolyte solution by absorption at the negative electrode or by irretrievable conversion to sulfite or sulfate, among other factors.

In some embodiments, a sulfide reservoir may be a “slow-release sulfide reservoir” in that they are configured to deliver sulfide ions to the electrolyte at a rate slower than a natural rate of dissolution of the same sulfide-source material placed directly in the electrolyte. In other words, “slow-release” sulfide reservoirs may have a rate of release of sulfide ions less than a natural dissolution rate of the sulfide-source material contained in the reservoir. Some embodiments of slow-release sulfide reservoirs may include structures and materials selected to dissolve and/or otherwise release sulfide ions at predictably slow rates under conditions expected to be experienced by the battery in operation. In some embodiments, the rate of sulfide ion release can be approximately matched with a rate of sulfide consumption (e.g., conversion to sulfate by oxygen or the positive electrode), such that an instantaneous sulfide concentration in the electrolyte at any given time or an average sulfide concentration over a period of time may be maintained within a desired range.

FIG. 1B illustrates multiple alternative locations inside and outside of the battery container 18 at which a sulfide reservoir may be located, along with corresponding ionic pathways and/or gas pathways. For example, sulfide reservoir may be completely or partially positioned in a head-space 24 above the electrolyte level 22. Another example embodiment is represented by sulfide reservoir 56 positioned such that a portion of the sulfide reservoir 56 extends below the electrolyte level 22. In some embodiments, the sulfide reservoir 56 may be rigidly secured to the battery container 18 (or another structure) at a fixed position relative to the electrolyte level 22. In some embodiments, a sulfide reservoir 58 may be positioned entirely below the electrolyte level. FIG. 1B shows sulfide reservoir 58 submerged below the electrolyte level 22. FIG. 1B also shows sulfide reservoir 62 positioned outside of the battery container 18. The sulfide reservoir 62 may be connected to the battery 10 by an electrolyte conduit 66 extending between the sulfide reservoir 62 and the electrolyte 22 within the battery container 18.

The presence of sulfide compounds in an iron-electrode battery may impact various performance metrics, including calendar life, cycle life, charge and/or discharge rate capability; the ability of the electrode to be discharged at relatively high rates, coulombic efficiency, self-discharge rate, and others. Sulfide is believed to participate in and/or to facilitate intermediate reactions during charging and/or discharging of iron electrodes. It is further believed that the sulfide which participates in such reactions is primarily in the form of sulfide ions dissolved in an aqueous electrolyte (i.e., an alkaline or acidic aqueous solution). Many electrolyte-soluble sulfide compounds may be used as a source-material for sulfide incorporation by an iron electrode. While various mechanisms have been proposed to describe exactly how sulfide benefits an iron-electrode battery, the inventors have shown clear benefits of its persistent presence on long-term performance of an iron-electrode battery.

Sulfide may be irretrievably lost from the iron electrode and from the electrolyte by multiple mechanisms under various conditions. Solid sulfide may be “lost” from the iron electrode by dissolution or electrochemical reduction to release sulfide into the bulk electrolyte. Dissolved sulfide ions may then be oxidized to sulfites or sulfates (or other sulfur compounds) on the positive electrode or by encountering dissolved oxygen in the electrolyte. It is believed that the oxidized sulfur species cannot be readily converted back into sulfides for participation in iron-electrode enhancing reactions.

The term “sulfide compound” refers to a chemical species comprising sulfide ion(s) or a chemical species which may dissociate into sulfide ion(s) upon dissolution in an electrolyte. A sulfide compound may refer to an “incorporated sulfide” compound, an “additive sulfide” compound, a “sulfide-source material” in a “sulfide reservoir”, or all of these (as those terms are defined in Pham publication '702 as referenced above). The term “sulfide ion” refers to S²⁻ or an ion comprising S²⁻. A sulfide ion may be present in solid form as part of a solid compound (e.g., a solid ionic compound). A sulfide ion may be a dissolved sulfide ion, such as a sulfide ion dissolved in an electrolyte. The term “sulfide” may refer to a sulfide ion or a sulfide ion-containing compound. In some embodiments, the term “sulfide” refers to sulfide ion(s). At least a portion of the additive sulfide in an iron electrode battery is in contact with an electrolyte.

The term “solubility limit” is generally understood to refer to a maximum amount of a solute that can dissolve in a solvent at a particular temperature and pressure. Solubility may be expressed as the mass of solute per volume (g/L), the mass of solute per mass of solvent (g/g), or as the moles of solute per volume (mol/L). A solution with the maximum possible amount of dissolved solute at a given temperature (i.e., when the solute concentration is equal to the solubility limit), the solution is referred to as “saturated.” In general, when a solution is saturated and excess solute is present, the rate of dissolution of the solute is equal to the rate of crystallization (or precipitation) of solid solute. A solution which contains more dissolved solute than the solubility limit is referred to as “supersaturated.”

As used herein, the “concentration” of a dissolved ionic species is the quantity of that ionic species per unit volume, typically expressed herein in terms of moles of ions per liter (mol/L), also referred to as molarity represented by the symbol “M”.

As used herein, the terms “crystal phase” and “crystal form” refers to the crystal structure of a crystallite, the crystal structure being characterized by a unit cell or repeating structural pattern of the atoms of the crystallite. The term “crystallite” refers to a single crystalline volume of a solid material having the same chemical composition and crystal structure throughout said volume. A crystallite may be a crystalline grain, for example, within a material such as a thin film or bulk material. A particle may be a single crystallite, for example, or may comprise one or more crystallites. A solid solution precipitate may be a single crystallite, for example, or may comprise one or more crystallites. In some cases, each discrete particle may be a single crystallite. Some particles, however, may comprise multiple crystallites, separated by grain boundaries, surface boundaries, and/or amorphous regions. Each crystallite in a material, such as a particle or thin film, may be separated from other crystallites by one or more surfaces, one or more grain boundaries (e.g., dislocations), one or more amorphous regions, one or more areas or volumes having different chemical composition, one or more areas or volumes having different crystal structure or polymorph or phase, or any combination of these.

An individual cubic ZnS crystallite is formed of ZnS having a cubic crystal structure, and is substantially (e.g., other than surface or ≤1 nm defects) or entirely free of amorphous ZnS and crystalline hexagonal ZnS. In various embodiments herein, each crystalline cubic ZnS particle may comprise only crystalline cubic ZnS, and may be substantially free of amorphous ZnS, unstructured cubic ZnS, and hexagonal ZnS (e.g., having less than 50 mass %, less than 25 mass %, less than 10 mass %, less than 5 mass %, less than 1 mass %, less than 0.1 mass %, less than 0.01 mass %, less than 0.005 mass %, less than 0.001 mass % of any combination of amorphous ZnS, unstructured cubic ZnS, and hexagonal ZnS).

An individual cubic MnS crystallite is formed of MnS having a cubic crystal structure of polymorph or phase, and is substantially (e.g., other than surface or ≤1 nm defects) or entirely free of amorphous MnS and crystalline hexagonal MnS. In various embodiments herein, each crystalline cubic MnS particle may comprise only crystalline cubic MnS, and may be substantially free of amorphous MnS, unstructured cubic MnS, and hexagonal MnS (e.g., having less than 50 mass %, less than 25 mass %, less than 10 mass %, less than 5 mass %, less than 1 mass %, less than 0.1 mass %, less than 0.01 mass %, preferably less than 0.005 mass %, more preferably less than 0.001 mass % of any combination of amorphous MnS, unstructured cubic MnS, and hexagonal MnS).

Descriptions, herein, of crystallite sizes and particle sizes refer to empirically-derived size characteristics of crystallites and particles, respectively, based on, determined by, or corresponding to data from any art-known technique or instrument that may be used to determine a crystallite size or particle size, such as x-ray diffraction (XRD), electron microscopy (SEM and/or TEM), or a light scattering technique (e.g., DLS). In embodiments, a size characteristic corresponds to a physical dimension, such as a cross-sectional size (e.g., length, width, thickness, diameter). Generally, to the extent not inconsistent with definitions and descriptions herein, the terms “grain boundary,” “surface,” “crystallite,” “amorphous,” “unstructured,” and “particle” have meanings recognized by one of skill in the art of materials science.

As used herein, the term “crystallinity” carries its ordinary meaning as understood by those of ordinary skill in the art and refers to the degree of structural order of atoms in a solid material. A material having a higher crystallinity comprises longer range of atomic structural order, on average, than a material having a lower crystallinity. A material having larger crystallites, on average, is characterized by higher crystallinity than a material having smaller crystallites, on average. Crystallinity may be evaluated or determined using crystallography techniques such as one or more X-ray diffraction (XRD) techniques to characterize a material, wherein broadening of one or more peaks (or, peak width) in an XRD pattern is inversely correlated with crystallinity and crystallite size. For example, larger crystallites of cubic ZnS (or cubic MnS) cause narrower peaks in XRD compared to smaller crystallites of cubic ZnS (or MnS), when the peaks are compared at respectively equivalent peak positions (20) and measurements are performed at otherwise identical conditions (e.g., same radiation, same instrument, same temperature, etc.).

Among other methods, crystallite size may be empirically estimated using a method based on the Scherrer equation for calculating crystallite size using XRD peak width. Crystallite size, for a sample, determined using a method based on the Scherrer equation may be referred to as a “Scherrer size. The Scherrer equation (Eq. 1) is:

$$τ = \frac{K λ}{β cos θ} \qquad ( Eq . 1 )$$

where τ is average crystallite size, K is a dimensionless shape factor, with a value close to unity (the shape factor has a typical value of about 0.9, but varies with the actual shape of the crystallite), λ is X-ray wavelength, β is the line broadening at half the maximum intensity (FWHM) after subtracting the instrumental line broadening (in radians), and θ is the Bragg angle corresponding to the peak position of the peak being thus analyzed. Scherrer size is an empirical estimation of average crystallite size, corresponding to the crystal phase, such as cubic, correlated with the peak(s) being analyzed in the Scherrer size calculation. The average crystallite size, such as of a cubic phase, can be estimated as the Scherrer size using a single peak position and/or as the average of Scherrer sizes based on multiple peak positions in a sample or material

Therefore, in the context of various embodiments described herein, a degree of crystallinity of a sulfide additive material may be quantified by one or more metrics, including with reference to a “Scherrer size” of a sample of the material, with reference to full-width at half-maximum measures of XRD peak width at peaks characteristic of a particular crystal form, or other methods or combinations of methods. Crystallite size and/or crystallinity may also be quantified or approximated using other methods, such as electron diffraction, such as using transmission electron microscopy (TEM) or scanning electron microscopy (SEM).

As used herein, the term “crystalline” is used to as an adjective to refer to materials or particles with an adequately high degree of crystallinity to achieve desired sulfide concentrations in the electrolyte. In some cases, an adequately high degree of crystallinity may be a degree of crystallinity that exceeds a threshold degree of crystallinity as measured by one or more techniques such as those described above.

In contrast to “crystalline” materials, the term “unstructured” is used herein as an adjective to refer to materials or particles with a low degree of crystallinity and/or including a significant quantity of amorphous-phase material. In some cases, unstructured material may have a degree of crystallinity falling below a threshold degree of crystallinity as measured by one or more of the metrics or techniques described above. Alternatively, or in addition, an unstructured material may be defined as having more than a threshold quantity of amorphous phase material.

As used herein, the term “unstructured” (such as in “unstructured cubic”) is a characterization referring to low, poor, or otherwise unfavorable crystallinity of a material for applications contemplated herein, in accordance with embodiments and descriptions herein, and is not intended to suggest that the material completely or absolutely lacks atomic structure or crystallinity. As will be further evident from the ensuing discussion, a material, particle, sample, or other object characterized as “unstructured” (such as an unstructured cubic ZnS additive) may comprise structure or crystallinity wherein said structure or crystallinity (e.g., of the cubic phase thereof) is characterized by a non-preferred degree (e.g., low crystallinity, too-broad XRD peaks, and/or too-small average crystallite size according to Scherrer equation or Halder-Wagner method) for certain embodiments and applications described herein. As merely an illustrative example, a ZnS additive characterized by a Scherrer crystal size of less than 100 Angstroms and/or characterized by the non-zero XRD peak at about 28.6 degrees (2θ, Cu K-α) having a full-width half-maximum value of greater than about 0.4 degrees may be characterized as being a unstructured cubic.

In some cases, a quantity of amorphous phase material may be determined or estimated using some of the same analytical tools described above, including XRD, TEM, and SEM. Although amorphous phase material does not produce unique peaks in an XRD, a quantity of amorphous phase material in a test sample may be determined by comparing its XRD results with those of a sample containing a known quantity of crystalline and amorphous material. Alternatively, an approximate quantity of amorphous material in a sample may be inferred based on an analysis of dissolution and re-precipitation behavior. As described in more detail below, when samples containing low-crystallinity ZnS and/or amorphous ZnS were placed in KOH electrolyte, excess dissolved material was found to re-precipitate primarily in the form of hexagonal ZnS, even if some amount of cubic ZnS was present in the pre-dissolution sample. Therefore, an iron electrode originally fabricated with a sulfide additive containing cubic ZnS and more than a threshold amount of amorphous ZnS can be expected to have a detectable quantity of hexagonal ZnS after a sufficient period of time (e.g., days, weeks, months, or longer after fabrication). Alternatively, the amount of crystalline cubic phase in an electrode can be determined by the following procedure. A piece of electrode can be rinsed to remove electrolyte, dried, analyzed by XRD using a scan rate of 0.5 to 10 degrees per minute, and the XRD analyzed via Rietveld refinement to obtain the mass fraction that is cubic ZnS. This can be multiplied by the molar mass of zinc divided by the molar mass of ZnS to obtain mass_Zn_cubic, the mass fraction of the sample that is Zn as cubic ZnS. Another piece of the same electrode can be rinsed to remove electrolyte, acid digested, analyzed by ICP-OES (inductively coupled plasma-optical emission spectroscopy) to obtain the mass fraction that is Zn, mass_Zn_total. The ratio of mass_Zn_cubic/mass_Zn_total is the mass % of the zinc sulfide additive which is in the form of cubic zinc sulfide.

Further, the present disclosure describes various materials or particles as having a high or low degree of crystallinity of a particular crystal phase. The term “unstructured cubic” refers to particles or materials with a cubic crystal phase characterized by a low degree of crystallinity, “crystalline cubic” refers to particles or materials with a cubic crystal phase and a high degree of crystallinity, “unstructured hexagonal” refers to particles or materials with a hexagonal crystal phase characterized by a low degree of crystallinity, and “crystalline hexagonal” refers to particles or materials with a hexagonal crystal phase characterized by a high degree of crystallinity.

Optionally, the term “unstructured cubic” refers to particles or materials with a cubic crystal phase characterized by a low degree of crystallinity and/or more than a threshold quantity of amorphous material, “crystalline cubic” refers to particles or materials with a cubic crystal phase and a high degree of crystallinity and less than a threshold quantity of amorphous material, “unstructured hexagonal” refers to particles or materials with a hexagonal crystal phase characterized by a low degree of crystallinity and/or more than a threshold quantity of amorphous material, and “crystalline hexagonal” refers to particles or materials with a hexagonal crystal phase characterized by a high degree of crystallinity and less than a threshold quantity of amorphous material.

For example, in some embodiments, a sample of ZnS or MnS (or other sulfide additive) may be considered to be “unstructured” if it has a cubic crystal phase characterized by a low degree of crystallinity and more than 10% by weight of the sulfide additive material is in an amorphous phase. In other embodiments, a threshold quantity of amorphous phase material sufficient to define a sulfide additive material as “unstructured,” in addition to the sulfide additive material having cubic crystal phase characterized by a low degree of crystallinity, may be 20%, 25%, 30%, 40%, 50%, 60%, or more by weight of the sulfide additive.

An iron-electrode battery with an electrolyte concentration of sulfide that is too low will tend to suffer poor rate capability, decreased capacity, high self-discharge rate and other degraded performance. On the other hand, high concentrations of sulfide in the electrolyte may also cause decreased performance due to corrosion or other detrimental effects on the iron electrode.

Therefore, a key to achieving a high-performance iron electrode battery is to maintain a concentration of sulfide in the electrolyte within a narrow band of acceptability. The inventors have found the ideal band of sulfide concentration to be between about 0.01 mmol/L and about 10 mmol/L. In some embodiments, an iron-electrode battery may comprise an electrolyte having a sulfide (or S²⁻) concentration selected from the range of 0.01±20% mmol/L to 10±20% mmol/L prior to and/or during charging and/or during discharging of the battery and/or while the battery is at open-circuit and/or in any other operational state. In some embodiments, an iron-electrode battery may comprise an electrolyte having a sulfide (or S²⁻) concentration less than that produced by the presence of hexagonal ZnS in contact with the electrolyte and more than that produced by having excess Bi₂S₃, CuS, PbS, Ir₂S₃, and/or CdS in contact with the electrolyte, prior to and/or during charging and/or during discharging of the battery and/or while the battery is at open-circuit and/or in any other operational state.

The life of an iron-electrode battery may be largely determined by the length of time and number of charge/discharge cycles during which the battery can maintain a sulfide concentration within this band. To achieve this, both thermodynamic solubility limits and kinetic dissolution rates may be managed to maintain sulfide concentration within the acceptable band, with replacement of sulfide lost by conversion to other sulfur species, but without supplying an excess of sulfide to the electrolyte. Several methods for achieving similar goals are described in Pham publication '702 as referenced above.

The “solubility limit” of a material is the maximum amount (or concentration) of a solute that can dissolve in a solvent at a specified temperature and pressure. If a solution contains a concentration of the solute in excess of the solubility limit, the solute will tend to precipitate. However, the actual concentration of a solute in a solution at any given moment may also be a factor of the time-dependent rates of dissolution and/or precipitation.

Soluble sulfide in electrolyte at a given point in time can be determined by collecting a representative sample from the electrolyte, degassing the sample with argon, combining the sample and sulfide anti-oxidant buffer (SAOB) in a 1:1 vol ratio, and measuring the potential of the mixed sample using a sulfide ion-selective electrode (ISE) that has been calibrated within the past hour against a set of standardized sulfide solutions in the appropriate concentration range. The standardized sulfide solutions should bracket the sulfide range of interest. For example, to measure 1.0E-4M accurately, the appropriate standards could cover the ranges from 10E-6 to 10E-3M. SAOB should be a fresh solution of 500 mL 2M NaOH and 18 g ascorbic acid. Alternatively, total sulfur can be determined using ICP-OES in combination with additional analysis steps, such as ion chromatography (IC), to distinguish between sulfide and any oxidized sulfur species. Using this second method (ICP-OES+IC or another technique), sulfide concentration should be the difference between total sulfur and other oxidized sulfur species present in solution. Sulfide is a reactive anion so all analyses need to be performed within a 4 h of collection or the sample needs to be preserved by degassing with argon followed by storage under inert gas (i.e. nitrogen, argon) until testing.

U.S. Pat. No. 4,250,236 to Haschka et al. (“Haschka”) suggests including sulfide iron-electrode additives in the form of a “sparingly soluble” metal sulfide. Specifically, Haschka writes “two examples of [sulfide-source additives] are zinc sulfide and manganese sulfide of which all known polymorphs are usable” (Haschka, col. 4, ll. 29-31, emphasis added). However, as the Inventors have discovered, some polymorphic forms of ZnS exhibit dramatically higher-than-expected dissolution rates in alkaline solutions, which can cause actual sulfide concentrations to at least temporarily far exceed thermodynamic solubility limits, leading to corrosion of the iron electrode, loss of sulfide, and degraded performance of the iron-electrode battery over its lifetime.

Published data and calculations of the solubility of zinc sulfide in 6M KOH alkaline solutions have shown a range of solubility limits from about 0.02 mM to about 0.7 mM. The inventors' own initial calculations suggest a solubility limit of ZnS in 6M KOH of about 0.3 mM (i.e., 0.0003 moles of sulfide per liter of KOH electrolyte).

However, surprisingly contrary to these expectations, the inventors found unexpected dissolution behavior of ZnS in a 6M KOH solution. The inventors observed the apparent solubility limit of ZnS increasing with increased quantity of ZnS added per unit volume of electrolyte and far exceeding reported solubility limits suggested by published literature and our own initial calculations. This result is illustrated in the data set of FIG. 1C. The inventors considered the possibility that ZnS was simply unexpectedly highly soluble in 6M KOH, but discovered a different and unexpected explanation. Without wishing to be bound by any particular theory of operation, it is believed that some crystal forms of ZnS produce sulfide concentrations exceeding their expected thermodynamic solubility limit due to differences in kinetics of dissolution and re-precipitation of the various crystal forms of ZnS and/or due to much larger than expected differences in solubility limits of the different crystal forms.

As shown in FIG. 1C, data suggests that the solubility of unstructured cubic ZnS is highly dependent on the ratio of ZnS solid to volume of electrolyte. Although not illustrated in FIG. 1C, hexagonal ZnS (both unstructured hexagonal ZnS and crystalline hexagonal ZnS) was found to exhibit similar dependence on the solid-to-liquid ratio. Notably, crystalline cubic ZnS does not show nearly the same pattern, suggesting a more stable and/or lower solubility.

Ultimately, data suggests that unstructured cubic ZnS and hexagonal ZnS (both unstructured hexagonal ZnS and crystalline hexagonal ZnS) are approximately an order of magnitude more soluble in KOH than crystalline cubic ZnS. An alternate explanation could be that some polymorphic forms of ZnS can actually dissolve at rates so fast that the dissolution out-runs the rate of re-precipitation of ZnS, causing the concentration of sulfide in solution to substantially exceed the thermodynamic solubility limit of ZnS in the solution under the same conditions. The Inventors also discovered that, once ZnS of any crystal phase is dissolved in KOH, it will re-precipitate in the faster-dissolving hexagonal crystal form (typically in low-crystallinity particles). Thus, an undesired dissolution feedback loop may be created by fast dissolution and re-precipitation in the fastest-dissolving crystal form, leading to an unfavorably high sulfide concentration in the electrolyte.

The Inventors found that dissolution of both unstructured and highly crystalline particles of the hexagonal wurtzite phase yield dissolved sulfide concentrations that are at least an order of magnitude greater than dissolved sulfide concentrations resulting from dissolution of highly crystalline particles of the cubic (or “sphalerite”) phase, under otherwise identical conditions. Unexpectedly, low-crystallinity particles made up of unit cells of the cubic phase also exhibited a very high rate of dissolution which produced solutions containing sulfide concentrations substantially exceeding the expected thermodynamic solubility limit of the cubic zinc sulfide. In fact, the low-crystallinity cubic ZnS particles exhibited similar dissolution behavior to both low-crystallinity hexagonal ZnS and high-crystallinity hexagonal ZnS particles.

After the unstructured cubic zinc sulfide dissolved in the electrolyte solution, the excess dissolved zinc sulfide (i.e., in excess of the thermodynamic solubility limit) re-precipitated as a solid. Unexpectedly, the dissolved sulfide re-precipitated in the faster-soluble hexagonal crystal form, thereby undesirably sustaining the high sulfide concentration in the electrolyte as the hexagonal ZnS particles quickly re-dissolved.

By contrast, particles of crystalline cubic zinc sulfide demonstrated both a substantially slower dissolution rate and a lower apparent solubility limit than the unstructured cubic particles as shown in FIG. 1C.

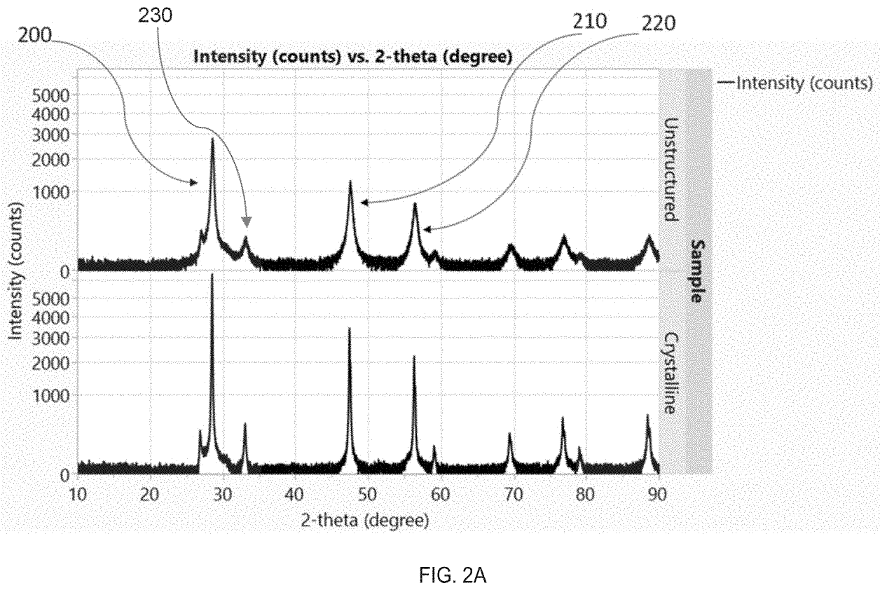

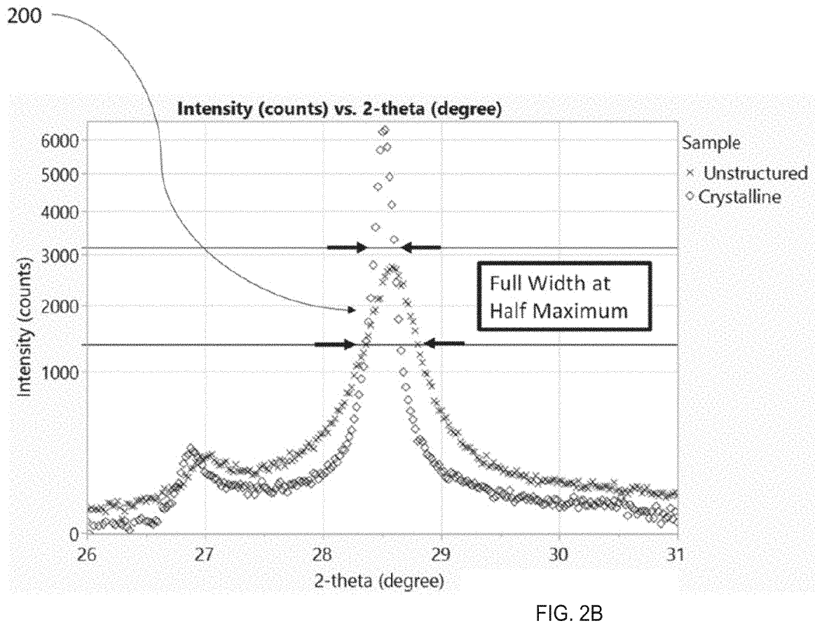

Crystalline cubic zinc sulfide with sufficiently high crystallinity may be recognized based on full-width at half-maximum (FWHM) measurements of selected peaks in an X-Ray diffraction (XRD) scan of a zinc sulfide samples, an example of which is illustrated in FIG. 2A and FIG. 2B. FIG. 2A is a schematic X-Ray Diffraction spectrum representing two sample iron electrodes containing an “unstructured” cubic zinc sulfide additive and a “crystalline” zinc sulfide additive. In FIG. 2A, the label 200 refers to the peak at 28.6 degrees, the label 210 refers to the peak at 47.6 degrees, the label 220 refers to the peak at 56.4 degrees, and the label 230 refers to the peak at 33.1 degrees. Samples with lower degrees of crystallinity will exhibit wider peaks at positions corresponding to cubic ZnS. Such wider peaks may be quantified in terms of FWHM values, which will be greater for less-crystalline samples and smaller (narrower) for more crystalline samples. In describing each diffraction peak, one can refer to the family of parallel crystal lattice planes that cause the diffraction peak, denoted by the Miller indices hkl. Peaks labelled 200, 210, 220, and 230 in FIG. 2A are indicative of cubic zinc sulfide. The peak labelled 200 at 28.6 degrees has Miller indices of (111). The peak labelled 230 at 33.1 degrees has Miller indices of (200). The peak labelled 210 at 47.6 degrees has Miller indices of (220). The peak labelled 220 at 56.4 degrees has Miller indices of (311). Miller indices and peak angles are determined by Rietveld refinement for ZnS in the cubic phase. Due to variance in XRD measurement systems, sample preparations, or other variable factors, these peak positions may be identified at about +/−0.1 degree from the above position values.

The peak labelled 200 in FIG. 2A is shown enlarged in FIG. 2B, which also illustrates the full-width at half-maximum (FWHM) measurement which is a measurement of the width of the curve at half the maximum value (the peak) of the curve. Due to variance in XRD measurement systems, sample preparations, user variations, or other variable factors, measured FWHM values may vary by about +/−0.05 degree from stated values. Unless otherwise stated, all XRD peak positions described herein correspond to 2θ degrees and Cu K-α radiation. When measuring the peak positions and FWHM, the XRD is scanned at a rate ranging from 0.5 to 10 degrees/minute, and the data are fit using Rietveld refinement.

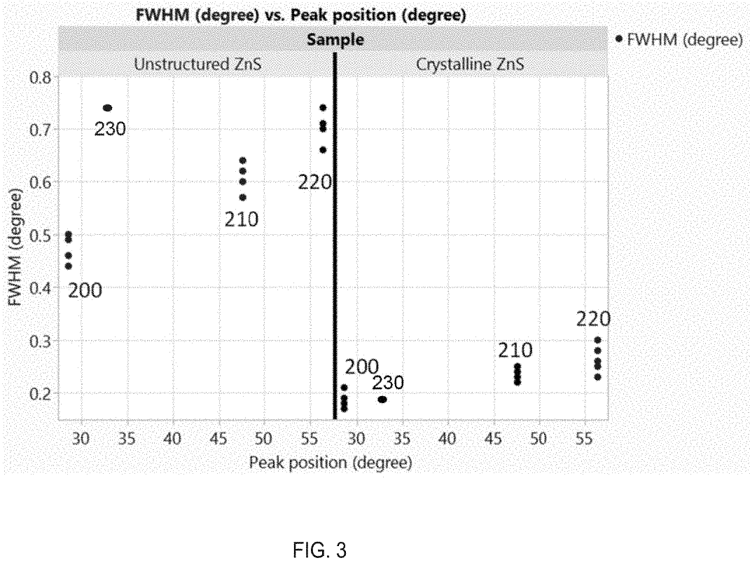

The predominant crystal phases or crystal structures of ZnS are the cubic form known as “zinc blende” or “sphalerite” and the hexagonal form known as “wurtzite.” In some embodiments, the terms “cubic zinc sulfide” and “crystalline cubic zinc sulfide” refer to zinc sulfide material (e.g., particle(s)) exhibiting non-zero XRD peaks characteristic of cubic zinc sulfide, such as peaks 200, 210, 220, and 230 such as illustrated in FIG. 2A and FIG. 3. For example, in some embodiments crystalline cubic zinc sulfide may exhibit one or more non-zero XRD peaks at 2θ angles characteristic of cubic zinc sulfide, such as a non-zero XRD peak at about 28.6 degrees (2θ, Cu K-α), with a full-width half-maximum value of less than about 0.4 degree, in other embodiments less than about 0.3 degree, in other embodiments less than about 0.2 degree, and in some particular embodiments no more than about 0.17 degree. Some embodiments of crystalline cubic zinc sulfide may exhibit a non-zero XRD peak at about 47.6 degrees with an FWHM value of less than about 0.5 degree, in other embodiments less than about 0.4 degree, in other embodiments less than about 0.3 degree, and in some particular embodiments no more than about 0.23 degree. In some embodiments, crystalline cubic zinc sulfide may exhibit a non-zero XRD peak at about 56.4 degrees with an FWHM value of less than about 0.6 degree, in other embodiments less than about 0.5 degree, in other embodiments less than about 0.4 degree, in other embodiments less than about 0.3 degree, and in some particular embodiments no more than about 0.23 degree. In other embodiments, “crystalline cubic zinc sulfide” may have slightly higher FWHM values at one or more of the above peak positions, provided that, when a least 0.01 grams of granular ZnS material per mL of electrolyte is placed in a 6M KOH electrolyte solution, the material produces a concentration of dissolved sulfide of less than about 0.001 moles per liter after 200 hours of soak time.

In embodiments, “crystalline cubic ZnS” or “crystalline cubic zinc sulfide” may refer to cubic ZnS (having peaks characteristic of cubic zinc sulfide including nominally at 28.6 degrees, 47.6 degrees, and 56.4 degrees of 2θ) characterized by one or more of the following: (a) the non-zero XRD peak at about 28.6 degrees (2θ, Cu K-α) having a full-width half-maximum value of less than about 0.4 degrees, in other embodiments less than about 0.3 degrees, in other embodiments less than about 0.2 degrees, and in some particular embodiments no more than about 0.17 degrees; (b) the non-zero XRD peak at about 47.6 degrees having a FWHM value of less than about 0.5 degrees, in other embodiments less than about 0.4 degrees, in other embodiments less than about 0.3 degrees, and in some particular embodiments no more than about 0.23 degrees; and/or (c) the non-zero XRD peak at about 56.4 degrees having a FWHM value of less than about 0.6 degrees, in other embodiments less than about 0.5 degrees, in other embodiments less than about 0.4 degrees, in other embodiments less than about 0.3 degrees, and in some particular embodiments no more than about 0.23 degrees.

The term “unstructured cubic ZnS” or “unstructured cubic zinc sulfide” may refer to cubic ZnS that is not or cannot be characterized as crystalline cubic ZnS or high-crystallinity cubic ZnS as described herein. In embodiments, “unstructured cubic ZnS” or “unstructured cubic zinc sulfide” may refer to cubic ZnS (having peaks characteristic of cubic zinc sulfide including nominally at 28.6 degrees, 47.6 degrees, and 56.4 degrees of 2θ) characterized by one or more of the following: (a) the non-zero XRD peak at about 28.6 degrees (2θ, Cu K-α) having a full-width half-maximum value of greater than or equal to about 0.4 degrees; (b) the non-zero XRD peak at about 47.6 degrees having a FWHM greater than or equal to about 0.5 degrees; and/or (c) the non-zero XRD peak at about 56.4 degrees having a FWHM value of greater than or equal to about 0.6 degrees. Alternatively or additionally, “unstructured cubic ZnS” or “unstructured cubic zinc sulfide” may refer to a ZnS compound with a grain size ≤25 nm via the Scherrer method, or ≤12 nm by the Halder-Wagner method measured via XRD. Other techniques for measuring grain sizes may be employed for measuring the grain size of the ZnS for determining whether the ZnS is “unstructured cubic ZnS” or “unstructured cubic zinc sulfide”, including by not limited to transmission electron microscopy and scanning electron microscopy. Although different measurement techniques may yield differing grain size results, the ability to approximately convert grain sizes between various techniques may be suitably applied to translate the grain size measurements via XRD into appropriate grain sizes for determining whether a ZnS material is a “unstructured cubic ZnS” or “unstructured cubic zinc sulfide” via other characterization techniques.

Likewise, the terms “unstructured cubic manganese sulfide” and “crystalline cubic manganese sulfide” refer to manganese sulfide material (e.g., particle(s) or film) exhibiting non-zero XRD peaks characteristic of cubic manganese sulfide. For example, in some embodiments crystalline cubic manganese sulfide may exhibit one or more non-zero XRD peaks, at 20 angles characteristic of cubic manganese sulfide, with a full-width half-maximum value of less than about 0.6 degrees, in other embodiments less than about 0.4 degree, in other embodiments less than about 0.3 degrees, and in some particular embodiments no more than about 0.2 degrees.

As used herein, the term “non-zero XRD peak” refers to a peak that can be found, fit, detected, or otherwise resolved from or above a background noise or a baseline using any of one or more art-known techniques or algorithms for finding, fitting, detecting, or otherwise resolving peaks in a data set. A non-zero XRD peak has a finite FWHM greater than 0 and a finite peak area greater than 0.

Two samples of un-treated ZnS and three samples of ZnS annealed under various conditions were evaluated by XRD to determine their crystallite sizes using the Scherrer equation. The un-treated samples were found to be “unstructured” ZnS due to the presence of low-crystallinity cubic ZnS and the possible presence of amorphous phase ZnS. The “treated” samples were found to be of sufficiently high crystallinity to produce desired dissolution characteristics as described herein. Using data from the same XRD scans, the crystallite sizes of the samples were calculated using two methods: a direct application of the Scherrer equation as described above, and an application of the Halder-Wagner method as implemented by the PDXL software from Rigaku installed on the X-ray diffractometer used. The data from those scans is summarized in Table 1 and Table 2 below. Although the two methods produced substantially different absolute values for the same samples, within each method a clear distinction can be seen between structured and crystalline samples. The value of K used in the Scherrer equation calculations was 0.9 and the wavelength λ was 1.5406 Angstroms.

TABLE 1
Measured FWHM (β) and calculated crystallite size for
Unstructured Cubic ZnS
Unstructured Cubic ZnS Samples

| | | | | Average | Crystallite |
|---|---|---|---|---|---|
| | | | Crystallite | Crystallite | size |
| | | | size at θ | Size at θ | from H-W |
| | | Miller | from | from | method in |
| 2θ | β | indices | Scherrer Eq. | Scherrer Eq. | PDXL |
| (deg.) | (degree) | (hkl) | (Angstrom) | (Angstrom) | (Angstrom) |
| 28.544 | 0.426 | 111 | 212.368 | 218 | 83 |
| 33.052 | 0.743 | 200 | — | | |
| 47.551 | 0.559 | 220 | 210.573 | | |
| 56.375 | 0.622 | 311 | 230.591 | | |
| 28.552 | 0.473 | 111 | 191.280 | 205 | 106 |
| 47.576 | 0.609 | 220 | 193.377 | | |
| 56.345 | 0.623 | 311 | 230.040 | | |

TABLE 2
Measured FWHM (β) and calculated crystallite
size for Crystalline Cubic ZnS
Crystalline Cubic ZnS Samples

| | | | | Average | Crystallite |
|---|---|---|---|---|---|
| | | | Crystallite | Crystallite | size |
| | | | Size | size | from H-W |
| | | Miller | at θ from | at θ from | method in |
| 2θ | β | indices | Scherrer Eq. | Scherrer Eq. | PDXL |
| (deg.) | (degree) | (hkl) | (Angstrom) | (Angstrom) | (Angstrom) |
| 28.488 | 0.129 | 111 | 700.936 | 865 | 393 |
| 33.006 | 0.191 | 200 | — | | |
| 47.458 | 0.137 | 220 | 857.681 | | |
| 56.315 | 0.138 | 311 | 1037.698 | | |
| 28.551 | 0.150 | 111 | 603.165 | 786 | 350 |
| 47.511 | 0.146 | 220 | 805.621 | | |
| 56.377 | 0.151 | 311 | 949.900 | | |
| 28.563 | 0.175 | 111 | 517.057 | 672 | 314 |
| 47.537 | 0.169 | 220 | 696.325 | | |
| 56.402 | 0.179 | 311 | 801.838 | | |

Therefore, in some embodiments of the systems and methods herein, ZnS may be adequately crystalline (and thereby referred to herein as crystalline cubic ZnS, or cubic ZnS characterized by high crystallinity) if the average crystallite size as calculated by the Scherrer equation is greater than or equal to about 250 Å, greater than or equal to about 300 Å, greater than or equal to about 400 Å, greater than or equal to about 500 Å, greater than or equal to about 600 Å, greater than or equal to about 700 Å, or greater than or equal to about 800 Å. Alternatively, in some embodiments of the systems and methods herein, ZnS may be adequately crystalline (and thereby referred to herein as crystalline cubic ZnS, or cubic ZnS characterized by high crystallinity) if a measurement of crystallite size performed by the Halder-Wagner method is greater than or equal to about 150 Å, greater than or equal to about 200 Å, greater than or equal to about 250 Å, greater than or equal to about 300 Å, greater than or equal to about 350 Å, or greater than or equal to about 400 Å.

In some embodiments, an iron-electrode battery may be substantially improved by including, as a sulfide-source additive, only crystalline cubic zinc sulfide particles, including those exhibiting XRD FWHM values characteristic of crystalline cubic ZnS as described herein. In various embodiments, crystalline cubic zinc sulfide may be included as an additive in an iron electrode in an amount of between about 0.01% and about 20% by weight of the iron electrode. In some particular embodiments, crystalline cubic zinc sulfide may be included as an additive in an iron electrode in an amount of between about 0.05% and about 10% by weight of the iron electrode, or between about 0.1% and about 5% by weight of the iron electrode. In various embodiments, crystalline cubic zinc sulfide may be included as an additive in an iron electrode in particle sizes from about 0.1 microns to about 500 microns, or in some embodiments from about 0.1 microns to about 20 microns, or from about 1 to 10 microns.

In an iron-electrode battery, having an additive of crystalline cubic zinc sulfide and/or crystalline cubic manganese sulfide (wherein the additive is substantially free or entirely free of amorphous zinc sulfide, amorphous manganese sulfide, unstructured zinc sulfide, unstructured manganese sulfide, hexagonal zinc sulfide, and/or hexagonal manganese sulfide) is contemplated herein to improve the battery's performance by several metrics. For example, a battery with cubic zinc sulfide in the iron electrode will tend to achieve increased cycle life, increased number of high-discharge-rate cycles (e.g., 1 C, 2 C, 3 C or faster discharge rates), higher energy efficiency, higher coulombic efficiency, improved charge retention, decreased self-discharge rates, and increased performance (e.g., as measured by any of the previous metrics) at higher temperatures. In some embodiments, using only high-crystallinity cubic zinc sulfide and/or high-crystallinity cubic manganese sulfide instead of unstructured cubic or hexagonal zinc sulfide and/or manganese sulfide, may improve and/or simplify electrode fabrication processes by decreasing solubility of the metal sulfide additive at intermediate processing steps. Iron electrodes incorporating crystalline cubic zinc sulfide and/or crystalline cubic manganese sulfide may be fabricated by any suitable process such as hot-pressing, cold-pressing, sintering, wet-paste lamination, dry pressing, slurry coating, PTFE based process, roll bonding, tape casting (blade coating), pocket-filling, or other suitable processes or combinations of such processes.

In some embodiments, crystalline cubic manganese sulfide (alabandite) may be used in place of or in combination with zinc sulfide in an iron-electrode battery. Crystalline cubic manganese sulfide (MnS) is expected to produce similar concentrations of sulfide as crystalline cubic zinc sulfide (ZnS) when dissolved in an alkaline battery electrolyte. In the same manner as described above, crystalline cubic MnS may be distinguished from other crystal forms of MnS by evaluating FWHM values of selected peaks in an X-ray Diffraction analysis of a sample of the material.

In some embodiments, instead of or in addition to including crystalline cubic zinc sulfide or cubic manganese sulfide as an additive in an iron electrode, a quantity of crystalline cubic zinc sulfide or cubic manganese sulfide may be used as a sulfide-source material in an iron-electrode battery exposed to an electrolyte but physically and electrically disconnected from an iron electrode. A sulfide-source material added to the electrolyte without being electrically connected to the iron electrode may be referred to herein as a “sulfide reservoir.”

Any sulfide additive described herein, having crystalline cubic ZnS and/or crystalline cubic MnS, may be added to the iron electrode (e.g., combining, adding to, or mixing with iron active material) during manufacture of the iron electrode or battery having the iron electrode. The sulfide additive may also be introduced in a manner permitting subsequent activation by electrochemical or chemical methods. Optionally, any iron electrode disclosed herein may comprise any combination of crystalline cubic ZnS and crystalline cubic MnS. Optionally, the iron electrode may comprise other low-solubility sulfide phases, such as antimony sulfide, bismuth sulfide, cadmium sulfide, cerium sulfide, cobalt sulfide, copper sulfide, copper disulfide, indium sulfide, iron sulfide, iron disulfide, lead sulfide, manganese disulfide, mercury sulfide, molybdenum disulfide, nickel sulfide, silver disulfide, and tin sulfide. For example, the iron electrode may comprise iron sulfide, manganese sulfide, tin sulfide, and zinc sulfide. The ZnS and MnS materials may contain impurities. The impurity content may be <2%, or <1%, or <0.5%, or <0.1%, or <0.01% by mass. The impurities may reside as dopants in the cubic ZnS lattice. Such dopants may cause slight shifts in the Bragg peak angles and/or broadening of the FWHM.

In various embodiments, crystalline cubic zinc sulfide may be made by various processes depending on the starting source material or materials. For example, one process for making crystalline cubic zinc sulfide from zinc sulfide starting material of unknown crystalline form and crystallinity may comprise evaluating the starting material to assess its crystal phase(s) and degree of crystallinity. As described above, the starting material's crystal phase (or phases) may be determined by the position of XRD peaks in an XRD scan. The FWHM values of the peaks corresponding to a given crystal phase may be used to evaluate the degree of crystallinity. Therefore, a zinc sulfide with peaks in the positions described above and with FWHM values within a range described above may already be usable in an iron-electrode battery.

However, if the FWHM values are too great (corresponding to wider peaks, and therefore undesirably low-crystallinity or undesirably low average crystallite size), then the starting material may be heat treated to increase crystallinity and/or average crystallite size. Such heat treatment may comprise annealing the starting material by heating to an elevated temperature of at least about 400° C. but less than the melting point of ZnS at about 1850° C. in a vacuum or an inert atmosphere (e.g., nitrogen, argon, or other inert gas) for a duration of at least about 5 seconds or as long as several hours, followed by slowly cooling the material back to room temperature. In some embodiments, heat treatment may comprise holding the material at a constant or varying elevated temperature for a duration of 30 minutes, one hour, two hours, three hours, four hours, five hours, or longer. In some particular embodiments, heat treatment may comprise heating the material to a temperature of between 800° C. and about 900° C., holding for about 10 to 20 minutes, followed by slowly cooling the material back to room temperature. In some embodiments, heating and/or cooling may be performed relatively slowly, such as at a ramp rate of up to about 20° C. per minute, in some embodiments about 10° C. per minute, or in some embodiments about 5° C. per minute, and in some embodiments less than 5° C. per minute. In some embodiments cooling to room temperature may be allowed to occur by natural convection without any controlled ramp rate.

Alternatively, amorphous ZnS (and/or MnS), unstructured or low-crystallinity cubic ZnS (and/or MnS), and/or hexagonal ZnS (and/or MnS) starting material may be heat-treated at such conditions as needed to allow for formation and/or growth of the cubic crystal structure to form crystalline cubic ZnS (and/or MnS) with a suitably high degree of crystallinity as described herein. In various embodiments, heat treatment of a ZnS and/or MnS material may be performed before, during, or after fabrication of an iron-electrode.

In some embodiments, crystalline cubic zinc sulfide may be made from raw materials including zinc and sulfur. For example, in some embodiments, solid zinc sulfide may be chemically precipitated from an aqueous solution containing dissolved zinc and dissolved sulfur (from any suitable source material). In some embodiments, conditions of a precipitation reaction, such as temperature, reactant concentrations, or inclusion of other additives, may be selected and controlled so as to produce crystalline cubic zinc sulfide precipitate. In other embodiments, a precipitation reaction may be used to produce solid amorphous, unstructured, or low-crystallinity zinc sulfide particles which may be subsequently heat-treated as described herein to produce substantially only crystalline cubic zinc sulfide.

In other embodiments, crystalline cubic zinc sulfide may be made from solid state reactions using solid zinc and sulfur raw materials in small particles (e.g., less than about 20 microns) at high-temperature (e.g., over 500° C.) and under vacuum or inert atmosphere.

In various embodiments, crystalline cubic MnS may be made using the same techniques as described above for making crystalline cubic ZnS. That is, crystalline cubic MnS may be made by annealing amorphous, unstructured, and/or low-crystallinity cubic MnS and/or hexagonal MnS at a temperature sufficient to achieve the crystalline cubic MnS. Alternatively, crystalline cubic MnS may be made by controlling a rate of precipitation of MnS from a solution containing dissolved Mn and S species, or by a high-temperature (e.g., greater than about 500° C.) reaction of Mn and S solids in a vacuum or inert atmosphere.

Various embodiments may include an electrochemical cell (e.g., 100, 10), such as a battery, having an iron negative electrode (also referred to as an iron anode) and an electrolyte (e.g., 102, 103, 20) having a total hydroxide concentration therein of above 3 M. In some embodiments, the electrolyte may have a total hydroxide concentration of above 3 M and up to or past a solubility limit of hydroxide in the electrolyte. In some embodiments, the electrolyte may have a total hydroxide concentration of above 3 M including greater than 3 M KOH+NaOH therein and greater than 0.01 M LiOH. In some embodiments, the electrolyte may have a total hydroxide concentration of less than or equal to 11 M therein. In some embodiments, the electrolyte may have a total hydroxide concentration of less than or equal to 11 M with less than or equal to 1 M LiOH therein and less than or equal to 10 M KOH+NaOH therein. In some embodiments, when the electrolyte is KOH based, the total hydroxide concentrations may be greater than 4 M and less than 10 M. However, the present disclosure is not limited to any particular concentration of the electrolyte.

As used herein, unless specified otherwise, the terms specific gravity, which is also called apparent density, should be given their broadest possible meanings, and generally mean weight per unit volume of a structure, e.g., volumetric shape of material. This property would include internal porosity of a particle as part of its volume. It can be measured with a low viscosity fluid that wets the particle surface, among other techniques.

As used herein, unless specified otherwise, the terms actual density, which may also be called true density, should be given their broadest possible meanings, and general mean weight per unit volume of a material, when there are no voids present in that material. This measurement and property essentially eliminates any internal porosity from the material, e.g., it does not include any voids in the material.

Thus, a collection of porous foam balls (e.g., Nerf® balls) can be used to illustrate the relationship between the three density properties. The weight of the balls filling a container would be the bulk density for the balls:

$$Bulk Density = \frac{weight of balls}{volume of container filled}$$

The weight of a single ball per the ball's spherical volume would be its apparent density:

$$Apparent Density = \frac{weight of one ball}{volume of that ball}$$

The weight of the material making up the skeleton of the ball, i.e., the ball with all void volume removed, per the remaining volume of that material would be the skeletal density:

$$Skeletal Density = \frac{weight of material}{volume of void free material}$$

Various embodiments are discussed in relation to the use of iron as a material in a battery (or cell) (e.g., 100, 10), as a component of a battery (or cell) (e.g., 100, 10), such as an electrode, and combinations and variations of these. In various embodiments, the iron material may be an iron powder such as a gas-atomized or water-atomized powder, or a sponge iron powder. In various embodiments, the iron material may be in the form of pellets, which may be spherical or substantially spherical. In various embodiments the iron material may be porous, containing open and/or closed internal porosity. In various embodiments the iron material may comprise materials that have been further processed by hot or cold briquetting. Embodiments of iron materials for use in various embodiments described herein, including as electrode materials, may have, one, more than one, or all of the material properties as described in Table 3 below. As used in the Specification, including Table 3, the following terms, have the following meaning, unless expressly stated otherwise: “Specific surface area” means, the total surface area of a material per unit of mass, which includes the surface area of the pores in a porous structure; “Total Fe (wt %)” means the mass of total iron as percent of total mass of iron material; “Metallic Fe (wt %)” means the mass of iron in the Fe⁰ state as percent of total mass of iron material.

TABLE 3

| Material Property | Embodiment Range |
|---|---|
| Specific surface area* | 0.01-25 m²/g |
| Skeletal density** | 4.6-7.8 g/cc |
| Apparent density*** | 1.5-6.5 g/cc |
| Total Fe (wt %)# | 65-100% |
| Metallic Fe (wt %)## | 46-100% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption′ and a Protein Retention (PR) method may be employed to provide results that can be correlated with BET results.
**Skeletal density preferably determined by helium (He) pycnometry, and more preferably as is set forth in ISO 12154 (the entire disclosure of which is incorporated herein by reference); recognizing that other tests may be employed to provide results that can be correlated with He pycnometry results. Skeletal density may also be referred to as “true density” or “actual density” in the art.
***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:
$Porosity = 1 - \frac{apparent density}{actual density}$ #Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can he correlated with dichromate titrimetry.
##Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.

Various embodiments are discussed in relation to the use of direct reduced iron (DRI) as a material a battery (or cell), as a component of a battery (or cell) and combinations and variations of these. In various embodiments, the DRI may be produced from, or may be, material which is obtained from the reduction of natural or processed iron ores, such reduction being conducted without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal)(Fe⁰, wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, direct reduced iron (“DRI”) pellets, Hot Briquetted Iron (HBI), or any combination thereof. In the iron and steelmaking industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 4 below. As used in the Specification, including Table 4, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass. Weight and volume percentages and apparent densities as used herein are understood to exclude any electrolyte that has infiltrated porosity or fugitive additives within porosity unless otherwise stated.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems, batteries for SDES systems, and/or batteries for systems needing power delivery for any time period. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

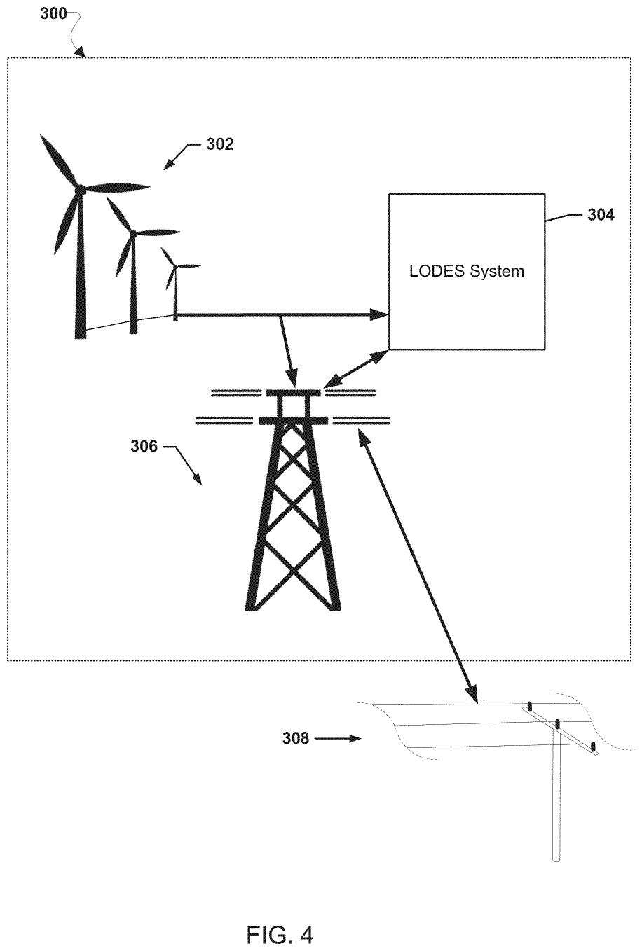

FIGS. 4-12 illustrate various example systems in which one or more aspects of the various embodiments may be used as part of bulk energy storage systems, such as LODES systems, SDES systems, systems needing power delivery for any time period, etc. For example, various embodiments described herein with reference to FIGS. 1A-3, such as electrochemical cells (or batteries) 100, 10, may be used as batteries for bulk energy storage systems, such as LODES systems, SDES systems, systems needing power delivery for any time period, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc. As further examples, various embodiments described herein with reference to FIGS. 1A-3, such as electrochemical cells (or batteries) 100, 10, may be used as batteries for backup power systems, such as backup power systems for telecommunications, data centers, electronic devices, transportation signals, medical facilities, or buildings. The duration of power delivery from the electrochemical cells (or batteries) 100, 10 may be of any duration. The durations of energy storage and/or power delivery described herein generally, and specifically with reference to FIGS. 4-12, are provided merely as examples and are not intended to be limiting.

FIG. 4 illustrates an example system in which one or more aspects of the various embodiments may be used as part of bulk energy storage system. While FIG. 4 is discussed in relation to an example LODES system 304, the durations of energy storage and/or power delivery described with reference to FIG. 4 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to the grid 308. The wind farm 302 may generate power and the wind farm 302 may output generated power to the LODES system 304 and/or the transmission facilities 306. The LODES system 304 may store power received from the wind farm 302 and/or the transmission facilities 306. The LODES system 304 may output stored power to the transmission facilities 306. The transmission facilities 306 may output power received from one or both of the wind farm 302 and LODES system 304 to the grid 308 and/or may receive power from the grid 308 and output that power to the LODES system 304. Together the wind farm 302, the LODES system 304, and the transmission facilities 306 may constitute a power plant 300 that may be a combined power generation, transmission, and storage system. The power generated by the wind farm 302 may be directly fed to the grid 308 through the transmission facilities 306, or may be first stored in the LODES system 304. In certain cases the power supplied to the grid 308 may come entirely from the wind farm 302, entirely from the LODES system 304, or from a combination of the wind farm 302 and the LODES system 304. The dispatch of power from the combined wind farm 302 and LODES system 304 power plant 300 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 300, the LODES system 304 may be used to reshape and “firm” the power produced by the wind farm 302. In one such example, the wind farm 302 may have a peak generation output (capacity) of 260 megawatts (MW) and a capacity factor (CF) of 41%. The LODES system 304 may have a power rating (capacity) of 106 MW, a rated duration (energy/power ratio) of 150 hours (h), and an energy rating of 15,900 megawatt hours (MWh). In another such example, the wind farm 302 may have a peak generation output (capacity) of 300 MW and a capacity factor (CF) of 41%. The LODES system 304 may have a power rating of 106 MW, a rated duration (energy/power ratio) of 200 h and an energy rating of 21,200 MWh. In another such example, the wind farm 302 may have a peak generation output (capacity) of 176 MW and a capacity factor (CF) of 53%. The LODES system 304 may have a power rating (capacity) of 88 MW, a rated duration (energy/power ratio) of 150 h and an energy rating of 13,200 MWh. In another such example, the wind farm 302 may have a peak generation output (capacity) of 277 MW and a capacity factor (CF) of 41%. The LODES system 304 may have a power rating (capacity) of 97 MW, a rated duration (energy/power ratio) of 50 h and an energy rating of 4,850 MWh. In another such example, the wind farm 302 may have a peak generation output (capacity) of 315 MW and a capacity factor (CF) of 41%. The LODES system 304 may have a power rating (capacity) of 110 MW, a rated duration (energy/power ratio) of 25 h and an energy rating of 2,750 MWh.

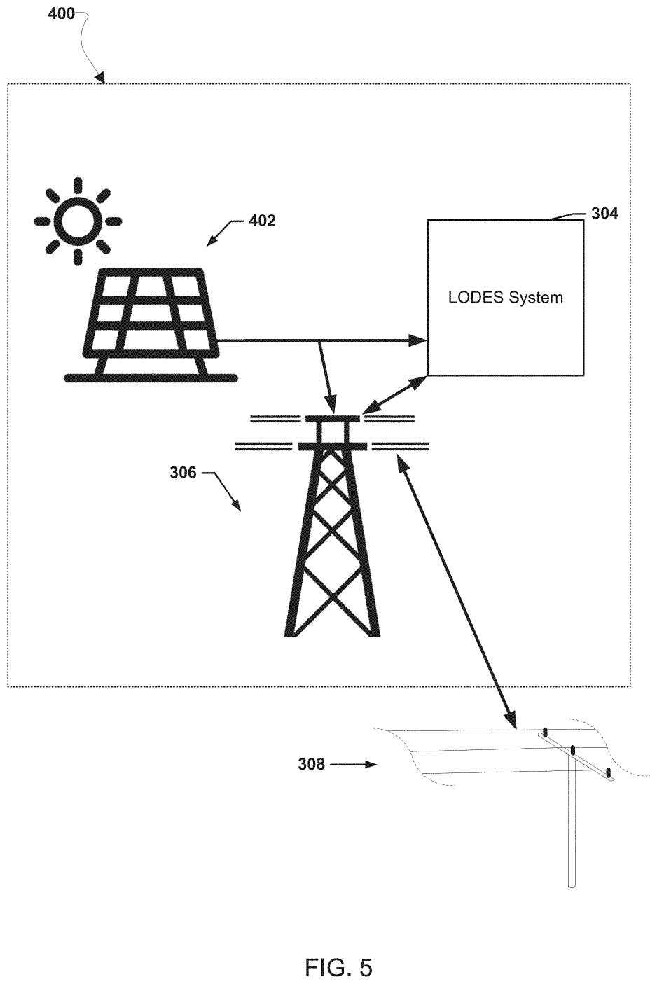

FIG. 5 illustrates an example system in which one or more aspects of the various embodiments may be used as part of bulk energy storage system. While FIG. 5 is discussed in relation to an example LODES system 304, the durations of energy storage and/or power delivery described with reference to FIG. 5 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 5 may be similar to the system of FIG. 4, except a photovoltaic (PV) farm 402 may be substituted for the wind farm 302. The LODES system 304 may be electrically connected to the PV farm 402 and one or more transmission facilities 306. The PV farm 402 may be electrically connected to the transmission facilities 306. The transmission facilities 306 may be electrically connected to the grid 308. The PV farm 402 may generate power and the PV farm 402 may output generated power to the LODES system 304 and/or the transmission facilities 306. The LODES system 304 may store power received from the PV farm 402 and/or the transmission facilities 306. The LODES system 304 may output stored power to the transmission facilities 306. The transmission facilities 306 may output power received from one or both of the PV farm 402 and LODES system 304 to the grid 308 and/or may receive power from the grid 308 and output that power to the LODES system 304. Together the PV farm 402, the LODES system 304, and the transmission facilities 306 may constitute a power plant 400 that may be a combined power generation, transmission, and storage system. The power generated by the PV farm 402 may be directly fed to the grid 308 through the transmission facilities 306, or may be first stored in the LODES system 304. In certain cases the power supplied to the grid 308 may come entirely from the PV farm 402, entirely from the LODES system 304, or from a combination of the PV farm 402 and the LODES system 304. The dispatch of power from the combined PV farm 402 and LODES system 304 power plant 400 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 400, the LODES system 304 may be used to reshape and “firm” the power produced by the PV farm 402. In one such example, the PV farm 402 may have a peak generation output (capacity) of 490 MW and a capacity factor (CF) of 24%. The LODES system 304 may have a power rating (capacity) of 340 MW, a rated duration (energy/power ratio) of 150 h and an energy rating of 51,000 MWh. In another such example, the PV farm 402 may have a peak generation output (capacity) of 680 MW and a capacity factor (CF) of 24%. The LODES system 304 may have a power rating (capacity) of 410 MW, a rated duration (energy/power ratio) of 200 h, and an energy rating of 82,000 MWh. In another such example, the PV farm 402 may have a peak generation output (capacity) of 330 MW and a capacity factor (CF) of 31%. The LODES system 304 may have a power rating (capacity) of 215 MW, a rated duration (energy/power ratio) of 150 h, and an energy rating of 32,250 MWh. In another such example, the PV farm 402 may have a peak generation output (capacity) of 510 MW and a capacity factor (CF) of 24%. The LODES system 304 may have a power rating (capacity) of 380 MW, a rated duration (energy/power ratio) of 50 h, and an energy rating of 19,000 MWh. In another such example, the PV farm 402 may have a peak generation output (capacity) of 630 MW and a capacity factor (CF) of 24%. The LODES system 304 may have a power rating (capacity) of 380 MW, a rated duration (energy/power ratio) of 25 h, and an energy rating of 9,500 MWh.

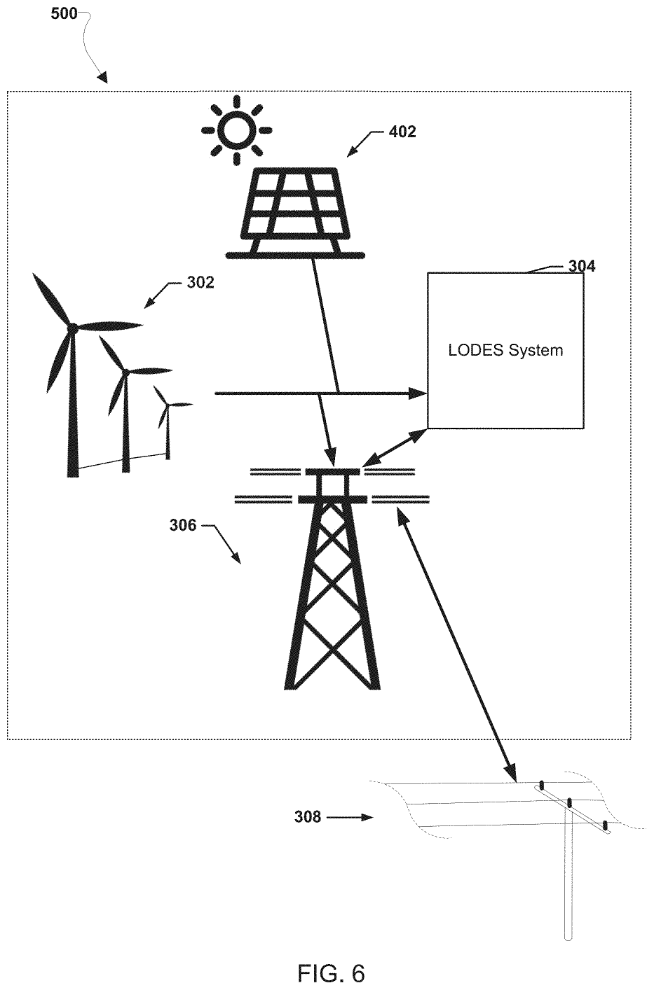

FIG. 6 illustrates an example system in which one or more aspects of the various embodiments may be used as part of bulk energy storage system. While FIG. 6 is discussed in relation to an example LODES system 304, the durations of energy storage and/or power delivery described with reference to FIG. 6 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The system of FIG. 6 may be similar to the systems of FIGS. 4 and 5, except the wind farm 302 and the photovoltaic (PV) farm 402 may both be power generators working together in the power plant 500. Together the PV farm 402, wind farm 302, the LODES system 304, and the transmission facilities 306 may constitute the power plant 500 that may be a combined power generation, transmission, and storage system. The power generated by the PV farm 402 and/or the wind farm 302 may be directly fed to the grid 308 through the transmission facilities 306, or may be first stored in the LODES system 304. In certain cases the power supplied to the grid 308 may come entirely from the PV farm 402, entirely from the wind farm 302, entirely from the LODES system 304, or from a combination of the PV farm 402, the wind farm 302, and the LODES system 304. The dispatch of power from the combined wind farm 302, PV farm 402, and LODES system 304 power plant 500 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 500, the LODES system 304 may be used to reshape and “firm” the power produced by the wind farm 302 and the PV farm 402. In one such example, the wind farm 302 may have a peak generation output (capacity) of 126 MW and a capacity factor (CF) of 41% and the PV farm 402 may have a peak generation output (capacity) of 126 MW and a capacity factor (CF) of 24%. The LODES system 304 may have a power rating (capacity) of 63 MW, a rated duration (energy/power ratio) of 150 h, and an energy rating of 9,450 MWh. In another such example, the wind farm 302 may have a peak generation output (capacity) of 170 MW and a capacity factor (CF) of 41% and the PV farm 402 may have a peak generation output (capacity) of 110 MW and a capacity factor (CF) of 24%. The LODES system 304 may have a power rating (capacity) of 57 MW, a rated duration (energy/power ratio) of 200 h, and an energy rating of 11,400 MWh. In another such example, the wind farm 302 may have a peak generation output (capacity) of 105 MW and a capacity factor (CF) of 51% and the PV farm 402 may have a peak generation output (capacity) of 70 MW and a capacity factor (CF) of 31 The LODES system 304 may have a power rating (capacity) of 61 MW, a rated duration (energy/power ratio) of 150 h, and an energy rating of 9,150 MWh. In another such example, the wind farm 302 may have a peak generation output (capacity) of 135 MW and a capacity factor (CF) of 41% and the PV farm 402 may have a peak generation output (capacity) of 90 MW and a capacity factor (CF) of 24%. The LODES system 304 may have a power rating (capacity) of 68 MW, a rated duration (energy/power ratio) of 50 h, and an energy rating of 3,400 MWh. In another such example, the wind farm 302 may have a peak generation output (capacity) of 144 MW and a capacity factor (CF) of 41% and the PV farm 402 may have a peak generation output (capacity) of 96 MW and a capacity factor (CF) of 24%. The LODES system 304 may have a power rating (capacity) of 72 MW, a rated duration (energy/power ratio) of 25 h, and an energy rating of 1,800 MWh.

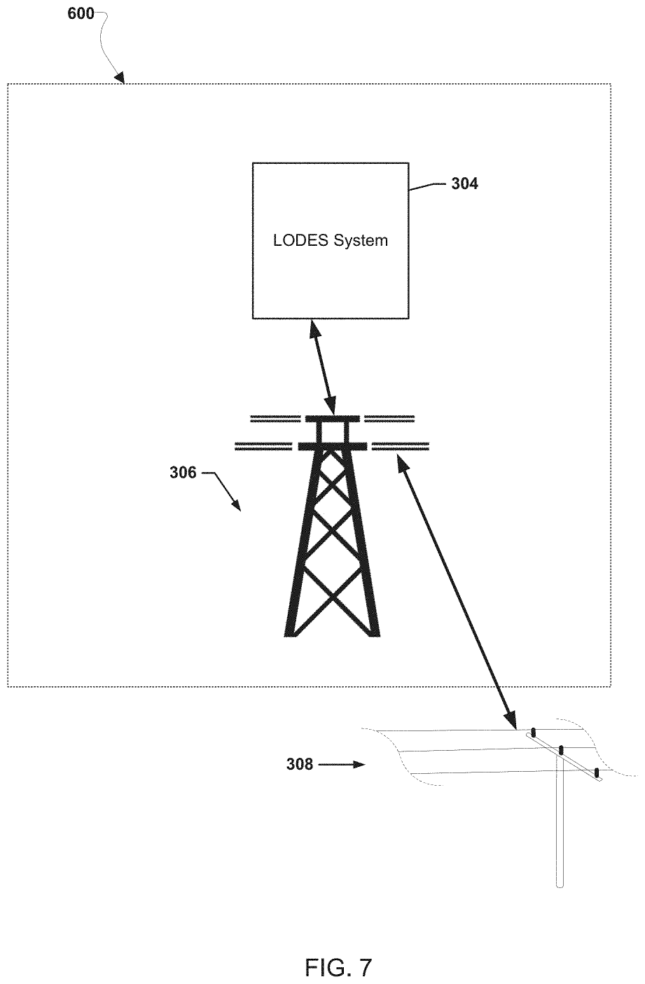

FIG. 7 illustrates an example system in which one or more aspects of the various embodiments may be used as part of bulk energy storage system. While FIG. 7 is discussed in relation to an example LODES system 304, the durations of energy storage and/or power delivery described with reference to FIG. 7 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to one or more transmission facilities 306. In this manner, the LODES system 304 may operate in a “stand-alone” manner to arbiter energy around market prices and/or to avoid transmission constraints. The LODES system 304 may be electrically connected to one or more transmission facilities 306. The transmission facilities 306 may be electrically connected to the grid 308. The LODES system 304 may store power received from the transmission facilities 306. The LODES system 304 may output stored power to the transmission facilities 306. The transmission facilities 306 may output power received from the LODES system 304 to the grid 308 and/or may receive power from the grid 308 and output that power to the LODES system 304.

Together the LODES system 304 and the transmission facilities 306 may constitute a power plant 900. As an example, the power plant 900 may be situated downstream of a transmission constraint, close to electrical consumption. In such an example downstream situated power plant 600, the LODES system 304 may have a duration of 24 h to 500 h and may undergo one or more full discharges a year to support peak electrical consumptions at times when the transmission capacity is not sufficient to serve customers. Additionally in such an example downstream situated power plant 600, the LODES system 304 may undergo several shallow discharges (daily or at higher frequency) to arbiter the difference between nighttime and daytime electricity prices and reduce the overall cost of electrical service to customer. As a further example, the power plant 600 may be situated upstream of a transmission constraint, close to electrical generation. In such an example upstream situated power plant 600, the LODES system 304 may have a duration of 24 h to 500 h and may undergo one or more full charges a year to absorb excess generation at times when the transmission capacity is not sufficient to distribute the electricity to customers. Additionally in such an example upstream situated power plant 600, the LODES system 304 may undergo several shallow charges and discharges (daily or at higher frequency) to arbiter the difference between nighttime and daytime electricity prices and maximize the value of the output of the generation facilities.

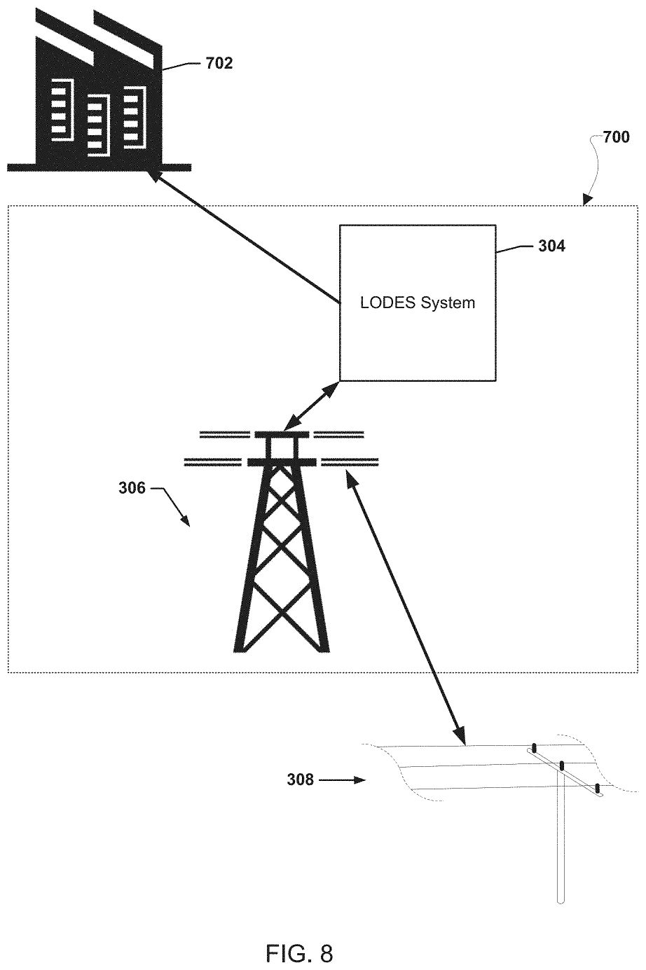

FIG. 8 illustrates an example system in which one or more aspects of the various embodiments may be used as part of bulk energy storage system. While FIG. 8 is discussed in relation to an example LODES system 304, the durations of energy storage and/or power delivery described with reference to FIG. 8 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a commercial and industrial (C&I) customer 702, such as a data center, factory, etc. The LODES system 304 may be electrically connected to one or more transmission facilities 306. The transmission facilities 306 may be electrically connected to the grid 308. The transmission facilities 306 may receive power from the grid 308 and output that power to the LODES system 304. The LODES system 304 may store power received from the transmission facilities 306. The LODES system 304 may output stored power to the C&I customer 702. In this manner, the LODES system 304 may operate to reshape electricity purchased from the grid 308 to match the consumption pattern of the C&I customer 702.

Together, the LODES system 304 and transmission facilities 306 may constitute a power plant 700. As an example, the power plant 700 may be situated close to electrical consumption, i.e., close to the C&I customer 702, such as between the grid 308 and the C&I customer 702. In such an example, the LODES system 304 may have a duration of 24 h to 500 h and may buy electricity from the markets and thereby charge the LODES system 304 at times when the electricity is cheaper. The LODES system 304 may then discharge to provide the C&I customer 702 with electricity at times when the market price is expensive, therefore offsetting the market purchases of the C&I customer 702. As an alternative configuration, rather than being situated between the grid 308 and the C&I customer 702, the power plant 700 may be situated between a renewable source, such as a PV farm, wind farm, etc., and the transmission facilities 306 may connect to the renewable source. In such an alternative example, the LODES system 304 may have a duration of 24 h to 500 h, and the LODES system 304 may charge at times when renewable output may be available. The LODES system 304 may then discharge to provide the C&I customer 702 with renewable generated electricity so as to cover a portion, or the entirety, of the C&I customer 702 electricity needs.

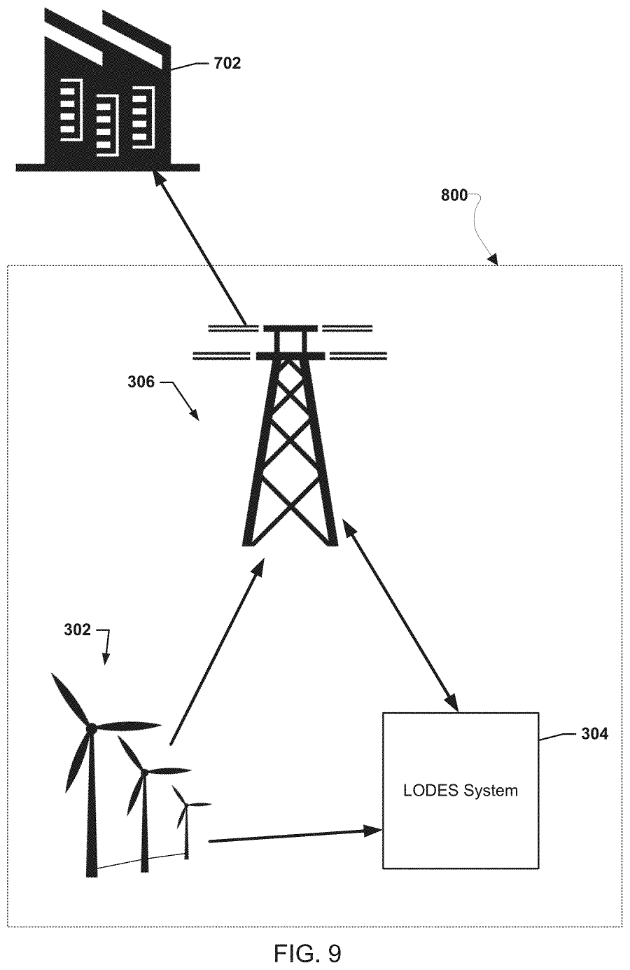

FIG. 9 illustrates an example system in which one or more aspects of the various embodiments may be used as part of bulk energy storage system. While FIG. 9 is discussed in relation to an example LODES system 304, the durations of energy storage and/or power delivery described with reference to FIG. 9 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be electrically connected to a wind farm 302 and one or more transmission facilities 306. The wind farm 302 may be electrically connected to the transmission facilities 306. The transmission facilities 306 may be electrically connected to a C&I customer 702. The wind farm 302 may generate power and the wind farm 302 may output generated power to the LODES system 304 and/or the transmission facilities 306. The LODES system 304 may store power received from the wind farm 302.

The LODES system 304 may output stored power to the transmission facilities 306. The transmission facilities 306 may output power received from one or both of the wind farm 302 and LODES system 304 to the C&I customer 702. Together the wind farm 302, the LODES system 304, and the transmission facilities 306 may constitute a power plant 800 that may be a combined power generation, transmission, and storage system. The power generated by the wind farm 302 may be directly fed to the C&I customer 702 through the transmission facilities 306, or may be first stored in the LODES system 304. In certain cases, the power supplied to the C&I customer 702 may come entirely from the wind farm 302, entirely from the LODES system 304, or from a combination of the wind farm 302 and the LODES system 304. The LODES system 304 may be used to reshape the electricity generated by the wind farm 302 to match the consumption pattern of the C&I customer 702. In one such example, the LODES system 304 may have a duration of 24 h to 500 h and may charge when renewable generation by the wind farm 302 exceeds the C&I customer 702 load. The LODES system 304 may then discharge when renewable generation by the wind farm 302 falls short of C&I customer 702 load so as to provide the C&I customer 702 with a firm renewable profile that offsets a fraction, or all of, the C&I customer 702 electrical consumption.

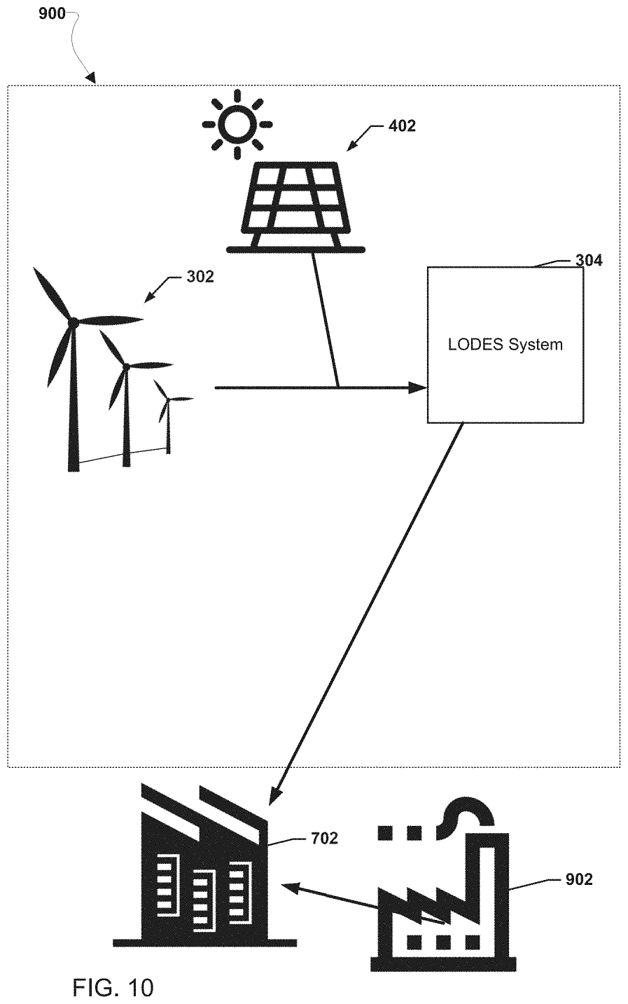

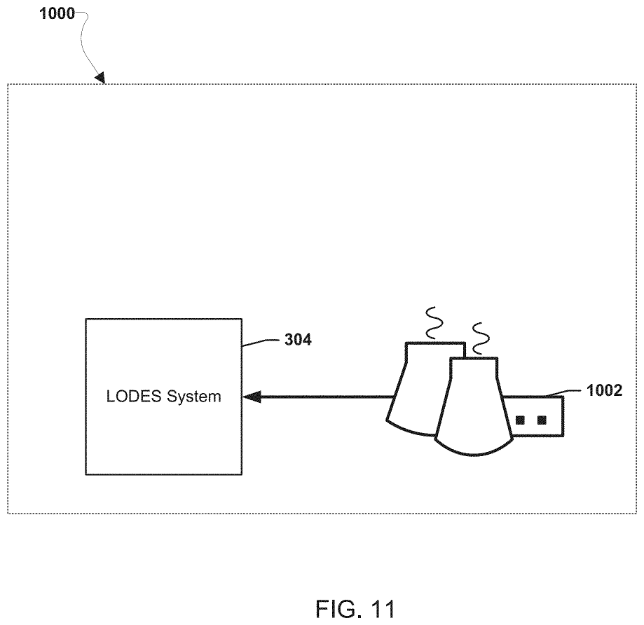

FIG. 10 illustrates an example system in which one or more aspects of the various embodiments may be used as part of bulk energy storage system. While FIG. 10 is discussed in relation to an example LODES system 304, the durations of energy storage and/or power delivery described with reference to FIG. 10 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be part of a power plant 900 that is used to integrate large amounts of renewable generation in microgrids and harmonize the output of renewable generation by, for example a PV farm 402 and wind farm 302, with existing thermal generation by, for example a thermal power plant 902 (e.g., a gas plant, a coal plant, a diesel generator set, etc., or a combination of thermal generation methods), while renewable generation and thermal generation supply the C&I customer 702 load at high availability. Microgrids, such as the microgrid constituted by the power plant 900 and the thermal power plant 902, may provide availability that is 90% or higher. The power generated by the PV farm 402 and/or the wind farm 302 may be directly fed to the C&I customer 702, or may be first stored in the LODES system 304.

In certain cases the power supplied to the C&I customer 702 may come entirely from the PV farm 402, entirely from the wind farm 302, entirely from the LODES system 304, entirely from the thermal power plant 902, or from any combination of the PV farm 402, the wind farm 302, the LODES system 304, and/or the thermal power plant 902. As examples, the LODES system 304 of the power plant 900 may have a duration of 24 h to 500 h. As a specific example, the C&I customer 702 load may have a peak of 100 MW, the LODES system 304 may have a power rating of 14 MW and duration of 150 h, natural gas may cost $6/million British thermal units (MMBTU), and the renewable penetration may be 58%. As another specific example, the C&I customer 702 load may have a peak of 100 MW, the LODES system 304 may have a power rating of 25 MW and duration of 150 h, natural gas may cost $8/MMBTU, and the renewable penetration may be 65%.

FIG. 11 illustrates an example system in which one or more aspects of the various embodiments may be used as part of bulk energy storage system. While FIG. 11 is discussed in relation to an example LODES system 304, the durations of energy storage and/or power delivery described with reference to FIG. 11 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may be used to augment a nuclear plant 1002 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 1000 constituted by the combined LODES system 304 and nuclear plant 1002. The nuclear plant 1002 may operate at high capacity factor and at the highest efficiency point, while the LODES system 304 may charge and discharge to effectively reshape the output of the nuclear plant 1002 to match a customer electrical consumption and/or a market price of electricity. As examples, the LODES system 304 of the power plant 1000 may have a duration of 24 h to 500 h. In one specific example, the nuclear plant 1002 may have 1,000 MW of rated output and the nuclear plant 1002 may be forced into prolonged periods of minimum stable generation or even shutdowns because of depressed market pricing of electricity. The LODES system 304 may avoid facility shutdowns and charge at times of depressed market pricing; and the LODES system 304 may subsequently discharge and boost total output generation at times of inflated market pricing.

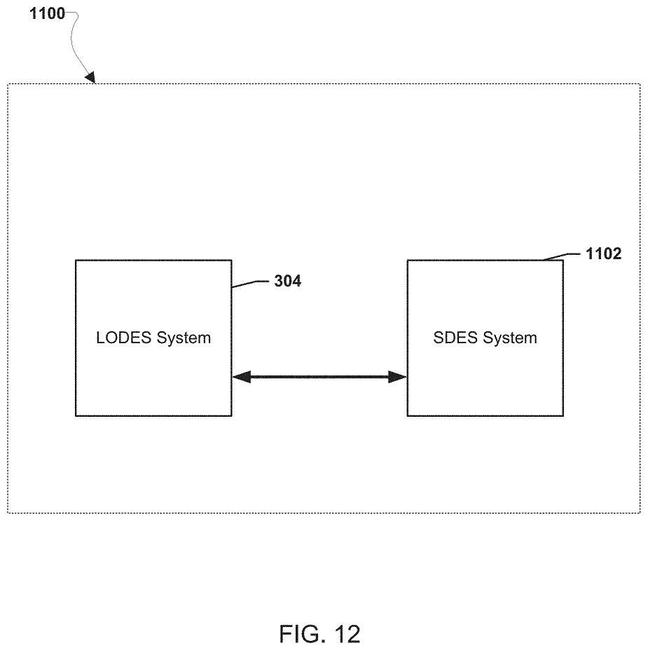

FIG. 12 illustrates an example system in which one or more aspects of the various embodiments may be used as part of bulk energy storage system. While FIG. 12 is discussed in relation to an example LODES system 304 and SDES system 1102, the durations of energy storage and/or power delivery described with reference to FIG. 12 are provided merely as examples and are not intended to limit the scope of the invention or claims. As a specific example, the bulk energy storage system incorporating one or more aspects of the various embodiments may be a LODES system 304. As an example, the LODES system 304 may include various embodiment batteries described herein, various electrodes described herein, etc. The LODES system 304 may operate in tandem with a SDES system 1102. Together the LODES system 304 and SDES system 1102 may constitute a power plant 1100. As an example, the LODES system 304 and SDES system 1102 may be co-optimized whereby the LODES system 304 may provide various services, including long-duration back-up and/or bridging through multi-day fluctuations (e.g., multi-day fluctuations in market pricing, renewable generation, electrical consumption, etc.), and the SDES system 1102 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 1102 may have durations of less than 10 hours and round-trip efficiencies of greater than 80%. The LODES system 304 may have durations of 24 h to 500 h and round-trip efficiencies of greater than 40%. In one such example, the LODES system 304 may have a duration of 150 hours and support customer electrical consumption for up to a week of renewable under-generation. The LODES system 304 may also support customer electrical consumption during intra-day under-generation events, augmenting the capabilities of the SDES system 1102. Further, the SDES system 1102 may supply customers during intra-day under-generation events and provide power conditioning and quality services such as voltage control and frequency regulation.

Various examples are provided below to illustrate aspects of the various embodiments. Example 1: A battery electrode comprising: an iron electrode body comprising iron active material and a zinc sulfide additive, wherein the zinc sulfide additive comprises crystalline cubic zinc sulfide. Example 2. The electrode of example 1, wherein the crystalline cubic zinc sulfide has a high degree of crystallinity as measured by at least one metric. Example 3. The electrode of example 1 or 2, wherein at least 75 mass % of the zinc sulfide additive is in the form of cubic zinc sulfide. Example 4. The electrode of example 3, wherein at least 90 mass % of the zinc sulfide additive is in the form of cubic zinc sulfide. Example 5. The electrode of example 4, wherein at least 99 mass % of the zinc sulfide additive is in the form of cubic zinc sulfide. Example 6. The electrode of example 5, wherein 100 mass % of the zinc sulfide additive is in the form of cubic zinc sulfide. Example 7. The electrode of any one of the preceding examples, wherein the crystalline cubic zinc sulfide is characterized by a non-zero x-ray diffraction (XRD) peak at 28.6±0.1 degrees with a full-width at half-maximum (FWHM) value of less than 0.4±0.1 degree. Example 8. The electrode of any one of the preceding examples, wherein the crystalline cubic zinc sulfide is characterized by a non-zero XRD peak at 47.6±0.1 degrees degree with an FWHM value of less than 0.5±0.1 degree. Example 9. The electrode of any one of the preceding examples, wherein the crystalline cubic zinc sulfide is characterized by a non-zero XRD peak at 56.4±0.1 degrees degree with an FWHM value of less than 0.6±0.1 degree. Example 10. The electrode of any one of the preceding examples, wherein the crystalline cubic zinc sulfide is present in the electrode as particles of between 0.1 micron and 500 micron in size. Example 11. The electrode of any one of the preceding examples, wherein the crystalline cubic zinc sulfide is present in an amount of between 0.01% and 20% by weight with respect to weight of the iron active material. Example 12. An iron electrode battery comprising an iron electrode and a sulfide reservoir separate from the iron electrode, the sulfide reservoir comprising crystalline cubic zinc sulfide. Example 13. The battery of example 12, wherein the crystalline cubic zinc sulfide has a high degree of crystallinity as measured by at least one metric. Example 14. The battery of example 12 or 13, wherein at least 75 mass % of the zinc sulfide additive is in the form of cubic zinc sulfide. Example 15. The battery of example 14, wherein at least 90 mass % of the zinc sulfide additive is in the form of cubic zinc sulfide. Example 16. The battery of example 15, wherein at least 99 mass % of the zinc sulfide additive is in the form of cubic zinc sulfide. Example 17. The battery of example 16, wherein 100 mass % of the zinc sulfide additive is in the form of cubic zinc sulfide. Example 18. The battery of any one of the preceding examples, wherein the crystalline cubic zinc sulfide is characterized by a non-zero x-ray diffraction (XRD) peak at 28.6±0.1 degrees with a full-width at half-maximum (FWHM) value of less than 0.4±0.1 degree. Example 19. The battery of any one of the preceding examples, wherein the crystalline cubic zinc sulfide is characterized by a non-zero XRD peak at 47.6±0.1 degrees degree with an FWHM value of less than 0.5±0.1 degree. Example 20. The battery of any one of the preceding examples, wherein the crystalline cubic zinc sulfide is characterized by a non-zero XRD peak at 56.4±0.1 degrees degree with an FWHM value of less than 0.6±0.1 degree. Example 21. The battery of any one of the preceding examples, wherein the crystalline cubic zinc sulfide is present in the electrode as particles of between 0.1 micron and 500 micron in size. Example 22. The battery of any one of the preceding examples, wherein the crystalline cubic zinc sulfide is present in an amount of between 0.01% and 20% by weight of the iron active material. Example 23. The battery of any one of the preceding examples, wherein the battery is a selected from the group consisting of an iron-air battery, a nickel-iron battery, and an iron-manganese dioxide battery. Example 24. The battery of any one of the preceding examples, comprising an electrolyte having a sulfide concentration selected from the range of 0.01±20% mmol/L to 10±20% mmol/L during operation of said battery. Example 25. A battery electrode comprising: an iron electrode body comprising iron active material and a manganese sulfide additive, wherein the manganese sulfide additive comprises crystalline cubic manganese sulfide. Example 26. The electrode of example 25, wherein the crystalline cubic zinc sulfide has a high degree of crystallinity as measured by at least one metric. Example 27. The electrode of example 25 or 26, wherein at least 75 mass % of the manganese sulfide additive is in the form of cubic manganese sulfide. Example 28. The electrode of example 27, wherein at least 90 mass % of the manganese sulfide additive is in the form of cubic manganese sulfide. Example 29. The electrode of example 28, wherein at least 99 mass % of the manganese sulfide additive is in the form of cubic manganese sulfide. Example 30. The electrode of example 29, wherein 100 mass % of the manganese sulfide additive is in the form of cubic manganese sulfide. Example 31. The electrode of any one of examples 25-30, wherein the crystalline cubic manganese sulfide is present in the electrode as particles of between 0.1 micron and 500 micron in size. Example 32. The electrode of any one of examples 25-31, wherein the crystalline cubic manganese sulfide is present in an amount of between 0.01% and 20% by weight of the iron active material. Example 33. An iron electrode battery comprising an iron electrode and a sulfide reservoir separate from the iron electrode, the sulfide reservoir comprising crystalline cubic manganese sulfide. Example 34. The battery of example 33, wherein the crystalline cubic zinc sulfide has a high degree of crystallinity as measured by at least one metric. Example 35. The battery of example 33 or 34, wherein at least 75 mass % of the manganese sulfide additive is in the form of cubic manganese sulfide. Example 36. The battery of example 35, wherein at least 90 mass % of the manganese sulfide additive is in the form of cubic manganese sulfide. Example 37. The battery of example 36, wherein at least 99 mass % of the manganese sulfide additive is in the form of cubic manganese sulfide. Example 38. The battery of example 37, wherein 100 mass % of the manganese sulfide additive is in the form of cubic manganese sulfide. Example 39. The battery of any one of examples 33-38, wherein the crystalline cubic manganese sulfide is present in the electrode as crystallites of between 0.1 micron and 500 micron in size. Example 40. The battery of any one of examples 33-39, wherein the crystalline cubic manganese sulfide is present in an amount of between 0.01% and 20% by weight of the iron active material. Example 41. The battery of any one of the preceding examples, wherein the battery is a member of the group consisting of an iron-air battery, a nickel-iron battery, and an iron-manganese dioxide battery. Example 42. The battery of any one of the preceding examples, comprising an electrolyte having a sulfide concentration selected from the range of 0.01±20% mmol/L to 10±20% mmol/L. Example 43. The battery of any one of the preceding examples comprising a positive electrode, a negative electrode, and at least one electrolyte, wherein the negative electrode comprises the iron electrode of any one of the preceding examples. Example 44. A method of making a battery according to any one of the preceding examples, the method comprising: fabricating the iron electrode body comprising iron active material and the manganese sulfide additive and/or the zinc sulfide additive. Example 45. A method of making an electrode according to any one of the preceding examples, the method comprising: fabricating the iron electrode body comprising iron active material and the manganese sulfide additive and/or the zinc sulfide additive. Example 46. The method of example 44 or 45, comprising combining the manganese sulfide additive and/or the zinc sulfide additive with the iron active material. Example 47. A method of operating the battery of any one of the preceding examples, the method comprising: charging and/or discharging the battery; wherein the battery comprises a negative electrode, a positive electrode, and an electrolyte; wherein the negative electrode comprises the iron electrode of any one of the preceding examples; and maintaining a sulfide concentration selected from the range of 0.01±20% mmol/L to 10±20% mmol/L during the step of charging and/or discharging. Example 48. The battery of any one of the preceding examples, wherein the iron electrode comprises less than 1 mass % of any combination of amorphous ZnS, unstructured cubic ZnS, crystalline hexagonal ZnS, amorphous MnS, unstructured cubic MnS, and crystalline hexagonal MnS prior to and/or during operation of the battery. Example 49. The electrode of any one of the preceding examples comprising less than 1 mass % of any combination of amorphous ZnS, unstructured cubic ZnS, crystalline hexagonal ZnS, amorphous MnS, unstructured cubic MnS, and crystalline hexagonal MnS.

Example A. A battery electrode comprising: an iron electrode body comprising iron active material and a zinc sulfide additive, wherein the zinc sulfide additive comprises crystalline cubic zinc sulfide. Example B. The electrode of example A, wherein the crystalline cubic zinc sulfide has a high degree of crystallinity as measured by at least one metric. Example C1. The electrode of example A or B, wherein at least 50 mass % of the zinc sulfide additive is in the form of cubic zinc sulfide. Example C2. The electrode of example A or B, wherein at least 75 mass % of the zinc sulfide additive is in the form of cubic zinc sulfide. Example C3. The electrode of example C2, wherein at least 90 mass % of the zinc sulfide additive is in the form of cubic zinc sulfide. Example D. The electrode of example C2, wherein at least 95 mass % of the zinc sulfide additive is in the form of cubic zinc sulfide. Example E. The electrode of example C3, wherein at least 99 mass % of the zinc sulfide additive is in the form of cubic zinc sulfide. Example F. The electrode of example E, wherein 100 mass % of the zinc sulfide additive is in the form of cubic zinc sulfide. Example G1. The electrode of any one of the preceding examples, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.4±0.1 degree. Example G2. The electrode of any one of the preceding examples, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.6±0.1 degree. Example G3. The electrode of any one of the preceding examples, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.45±0.1 degree. Example G4. The electrode of any one of the preceding examples, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.3±0.1 degree. Example H1. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.5±0.1 degree. Example H2. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.45±0.1 degree. Example H3. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.3±0.1 degree. Example H4. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.6±0.1 degree. Example H5. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.35±0.1 degree. Example H6. The electrode of any one of the preceding examples, wherein the crystalline cubic zinc sulfide is characterized by a non-zero XRD peak for cubic ZnS with Miller indices (220) as determined by Rietveld refinement at 47.6 degrees with an FWHM value of less than 0.2±0.1 degree. Example I1. The electrode of any one of the preceding examples, wherein the crystalline cubic zinc sulfide is characterized by a non-zero XRD peak for cubic ZnS with Miller indices (311) as determined by Rietveld refinement at 56.4 degrees with an FWHM value of less than 0.6±0.1 degree. Example I2. The electrode of any one of the preceding examples, wherein the crystalline cubic zinc sulfide is characterized by a non-zero XRD peak for cubic ZnS with Miller indices (311) as determined by Rietveld refinement at 56.4 degrees with an FWHM value of less than 0.45±0.1 degree. Example I3. The electrode of any one of the preceding examples, wherein the crystalline cubic zinc sulfide is characterized by a non-zero XRD peak for cubic ZnS with Miller indices (311) as determined by Rietveld refinement at 56.4 degrees with an FWHM value of less than 0.35±0.1 degree. Example J1. The electrode of any one of the preceding examples, wherein the crystalline cubic zinc sulfide is characterized by a non-zero XRD peak for cubic ZnS with Miller indices (200) as determined by Rietveld refinement at 33.1 degrees with an FWHM value of less than 0.6±0.1 degree. Example J2. The electrode of any one of the preceding examples, wherein the crystalline cubic zinc sulfide is characterized by a non-zero XRD peak for cubic ZnS with Miller indices (200) as determined by Rietveld refinement at 33.1 degrees with an FWHM value of less than 0.45±0.1 degree. Example J3. The electrode of any one of the preceding examples, wherein the crystalline cubic zinc sulfide is characterized by a non-zero XRD peak for cubic ZnS with Miller indices (200) as determined by Rietveld refinement at 33.1 degrees with an FWHM value of less than 0.4±0.1 degree. Example J4. The electrode of any one of the preceding examples, wherein the crystalline cubic zinc sulfide is characterized by a non-zero XRD peak for cubic ZnS with Miller indices (200) as determined by Rietveld refinement at 33.1 degrees with an FWHM value of less than 0.3±0.1 degree. Example J5. The electrode of any one of the preceding examples, wherein the crystalline cubic zinc sulfide is characterized by a non-zero XRD peak for cubic ZnS with Miller indices (200) as determined by Rietveld refinement at 33.1 degrees with an FWHM value of less than 0.2±0.1 degree. Example K. The electrode of any one of the preceding examples, wherein the crystalline cubic zinc sulfide is present in the electrode as particles of between 0.1 micron and 500 micron in size. Example L. The electrode of any one of the preceding examples, wherein the crystalline cubic zinc sulfide is present in an amount of between 0.01% and 20% by weight with respect to weight of the iron active material. Example M. An iron electrode battery comprising an iron electrode and a sulfide reservoir separate from the iron electrode, the sulfide reservoir comprising crystalline cubic zinc sulfide. Example N. The battery of example M, wherein the crystalline cubic zinc sulfide has a high degree of crystallinity as measured by at least one metric. Example O. The battery of example M or N, wherein at least 50 mass % of the zinc sulfide additive is in the form of cubic zinc sulfide. Example P. The battery of example 0, wherein at least 75 mass % of the zinc sulfide additive is in the form of cubic zinc sulfide. Example Q. The battery of example P, wherein at least 90 mass % of the zinc sulfide additive is in the form of cubic zinc sulfide. Example R1. The battery of example Q, wherein 95 mass % of the zinc sulfide additive is in the form of cubic zinc sulfide. Example R2. The battery of example Q, wherein 99 mass % of the zinc sulfide additive is in the form of cubic zinc sulfide. Example R3. The battery of example Q, wherein 100 mass % of the zinc sulfide additive is in the form of cubic zinc sulfide. Example S. The battery of any one of the preceding examples, wherein the crystalline cubic zinc sulfide is characterized by a non-zero x-ray diffraction (XRD) peak at 28.6±0.1 degrees with a full-width at half-maximum (FWHM) value of less than 0.4±0.1 degree. Example T. The battery of any one of the preceding examples, wherein the crystalline cubic zinc sulfide is characterized by a non-zero XRD peak at 47.6±0.1 degrees with an FWHM value of less than 0.5±0.1 degree. Example U. The battery of any one of the preceding examples, wherein the crystalline cubic zinc sulfide is characterized by a non-zero XRD peak at 56.4±0.1 degrees with an FWHM value of less than 0.6±0.1 degree. Example V. The battery of any one of the preceding examples, wherein the crystalline cubic zinc sulfide is present in the electrode as particles of between 0.1 micron and 500 micron in size. Example W. The battery of any one of the preceding examples, wherein the crystalline cubic zinc sulfide is present in an amount of between 0.01% and 20% by weight of the iron active material. Example X. The battery of any one of the preceding examples, wherein the battery is a selected from the group consisting of an iron-air battery, a nickel-iron battery, and an iron-manganese dioxide battery. Example Y. The battery of any one of the preceding examples, comprising an electrolyte having a sulfide concentration selected from the range of 0.01±20% mmol/L to 10±20% mmol/L during operation of said battery. Example Z. A battery electrode comprising: an iron electrode body comprising iron active material and a manganese sulfide additive, wherein the manganese sulfide additive comprises crystalline cubic manganese sulfide. Example AA. The electrode of example Z, wherein the crystalline cubic manganese sulfide has a high degree of crystallinity as measured by at least one metric. Example AB. The electrode of example Z or AA, wherein at least 50 mass % of the manganese sulfide additive is in the form of cubic manganese sulfide. Example AC. The electrode of example AB, wherein at least 75 mass % of the manganese sulfide additive is in the form of cubic manganese sulfide. Example AD. The electrode of example AC, wherein at least 90 mass % of the manganese sulfide additive is in the form of cubic manganese sulfide. Example AE1. The electrode of example AD, wherein 95 mass % of the manganese sulfide additive is in the form of cubic manganese sulfide. Example AE2. The electrode of example AD, wherein 99 mass % of the manganese sulfide additive is in the form of cubic manganese sulfide. Example AE3. The electrode of example AD, wherein 100 mass % of the manganese sulfide additive is in the form of cubic manganese sulfide. Example AF. The electrode of any one of examples Z-AE3, wherein the crystalline cubic manganese sulfide is present in the electrode as particles of between 0.1 micron and 500 micron in size. Example AG. The electrode of any one of examples Z-AF, wherein the crystalline cubic manganese sulfide is present in an amount of between 0.01% and 20% by weight of the iron active material. Example AH. An iron electrode battery comprising an iron electrode and a sulfide reservoir separate from the iron electrode, the sulfide reservoir comprising crystalline cubic manganese sulfide. Example AI. The battery of example AH, wherein the crystalline cubic manganese sulfide has a high degree of crystallinity as measured by at least one metric. Example AJ. The battery of example AH or AI, wherein at least 50 mass % of the manganese sulfide additive is in the form of cubic manganese sulfide. Example AJ. The battery of example AJ, wherein at least 75 mass % of the manganese sulfide additive is in the form of cubic manganese sulfide. Example AK. The battery of example AJ, wherein at least 90 mass % of the manganese sulfide additive is in the form of cubic manganese sulfide. Example ALL The battery of example AK, wherein 95 mass % of the manganese sulfide additive is in the form of cubic manganese sulfide. Example AL2. The battery of example AK, wherein 99 mass % of the manganese sulfide additive is in the form of cubic manganese sulfide. Example AL3. The battery of example AK, wherein 100 mass % of the manganese sulfide additive is in the form of cubic manganese sulfide. Example AM. The battery of any one of examples AH-AL3, wherein the crystalline cubic manganese sulfide is present in the electrode as crystallites of between 0.1 micron and 500 micron in size. Example AN. The battery of any one of examples AH-AM, wherein the crystalline cubic manganese sulfide is present in an amount of between 0.01% and 20% by weight of the iron active material. Example AO. The battery of any one of the preceding examples, wherein the battery is a member of the group consisting of an iron-air battery, a nickel-iron battery, and an iron-manganese dioxide battery. Example AP. The battery of any one of the preceding examples, comprising an electrolyte having a sulfide concentration selected from the range of 0.01±20% mmol/L to 10±20% mmol/L. Example AQ. The battery of any one of the preceding examples comprising a positive electrode, a negative electrode, and at least one electrolyte, wherein the negative electrode comprises the iron electrode of any one of the preceding examples. Example AR. The battery of any one of the preceding examples comprising a positive electrode, a negative electrode, and at least one electrolyte, wherein the negative electrode comprises antimony sulfide, bismuth sulfide, cadmium sulfide, cerium sulfide, cobalt sulfide, copper sulfide, copper disulfide, indium sulfide, iron sulfide, iron disulfide, lead sulfide, manganese disulfide, mercury sulfide, molybdenum disulfide, nickel sulfide, silver disulfide, and tin sulfide. Example AS. A method of making a battery according to any one of the preceding examples, the method comprising: fabricating an iron electrode body comprising iron active material and at least one of a manganese sulfide additive and a zinc sulfide additive. Example AT. A method of making an electrode according to any one of the preceding examples, the method comprising: fabricating the iron electrode body comprising iron active material and at least one of a manganese sulfide additive and a zinc sulfide additive. Example AU. The method of example AS or AT, comprising combining the manganese sulfide additive and/or the zinc sulfide additive with the iron active material. Example AV. A method of operating the battery of any one of the preceding examples, the method comprising: charging and/or discharging the battery; wherein the battery comprises a negative electrode, a positive electrode, and an electrolyte; wherein the negative electrode comprises the iron electrode of any one of the preceding examples; and maintaining a sulfide concentration selected from the range of 0.01±20% mmol/L to 10±20% mmol/L during the step of charging and/or discharging. Example AW. The battery of any one of the preceding examples, wherein the iron electrode comprises less than 1 mass % of any combination of amorphous ZnS, unstructured cubic ZnS, crystalline hexagonal ZnS, amorphous MnS, unstructured cubic MnS, and crystalline hexagonal MnS prior to and/or during operation of the battery. Example AX. The electrode of any one of the preceding examples comprising less than 1 mass % of any combination of amorphous ZnS, unstructured cubic ZnS, crystalline hexagonal ZnS, amorphous MnS, unstructured cubic MnS, and crystalline hexagonal MnS. Example AY. A bulk energy storage system, comprising one or more electrodes and/or one or more batteries of any of examples A-AX. Example AZ. A long duration energy storage system configured to hold an electrical charge for at least 24 hours, the system comprising one or more electrodes and/or one or more batteries of any of examples A-AX.

Any of the aspects and embodiments disclosed herein may be combined with any of the aspects and embodiments disclosed in Pham publication '702 as referenced above.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Various modifications to the above embodiments will be readily apparent to those skilled in the art, and the generic principles defined herein may be applied to other embodiments without departing from the spirit or scope of the invention. Thus, it is intended that the scope of the present invention herein disclosed should not be limited by the particular disclosed embodiments described above, but should be determined only by a fair reading of the claims that follow.

The term “substantially” refers to a property, condition, or value that is within 20%, 10%, within 5%, within 1%, optionally within 0.1%, or is equivalent to a reference property, condition, or value. The term “substantially equal”, “substantially equivalent”, or “substantially unchanged”, when used in conjunction with a reference value describing a property or condition, refers to a value that is within 20%, within 10%, optionally within 5%, optionally within 1%, optionally within 0.1%, or optionally is equivalent to the provided reference value. For example, a diameter is substantially equal to 100 nm (or, “is substantially 100 nm”) if the value of the diameter is within 20%, optionally within 10%, optionally within 5%, optionally within 1%, optionally within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value. As used herein, the terms “about” and “substantially” are interchangeably and have identical means. For example, a particle having a size of about 1 μm is understood to have a size is within 20%, optionally within 10%, optionally within 5%, optionally within 1%, optionally within 0.1%, or optionally equal to 1 μm.

In particular, materials and manufacturing techniques may be employed as within the level of those with skill in the relevant art. Furthermore, reference to a singular item, includes the possibility that there are plural of the same items present. More specifically, as used herein and in the appended claims, the singular forms “a,” “and,” “said,” and “the” include plural referents unless the context clearly dictates otherwise. As used herein, unless explicitly stated otherwise, the term “or” is inclusive of all presented alternatives, and means essentially the same as the phrase “and/or.” It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

The term “±” refers to an inclusive range of values, such that “X±Y,” wherein each of X and Y is independently a number, refers to an inclusive range of values selected from the range of X-Y to X+Y.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

1. A battery electrode, comprising:
an iron electrode body comprising iron active material and a zinc sulfide additive, wherein the zinc sulfide additive comprises crystalline cubic zinc sulfide.

2. The electrode of claim 1, wherein the crystalline cubic zinc sulfide has a high degree of crystallinity as measured by at least one metric.

3. The electrode of claim 1, wherein at least 50 mass % of the zinc sulfide additive is in the form of cubic zinc sulfide.

4. The electrode of claim 3, wherein at least 75 mass % of the zinc sulfide additive is in the form of cubic zinc sulfide.

5. The electrode of claim 4, wherein at least 90 mass % of the zinc sulfide additive is in the form of cubic zinc sulfide.

6. The electrode of claim 5, wherein 95 mass % of the zinc sulfide additive is in the form of cubic zinc sulfide.

7. The electrode of claim 16, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.6±0.1 degree.

8. The electrode of claim 1, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.45±0.1 degree.

9. The electrode of claim 1, wherein the crystalline cubic zinc sulfide is characterized by a non-zero x-ray diffraction (XRD) peak for cubic ZnS with Miller indices (111) as determined by Rietveld refinement at 28.6 degrees with a full-width at half-maximum (FWHM) value of less than 0.3±0.1 degree.

10. The electrode of claim 1, wherein the crystalline cubic zinc sulfide is characterized by a non-zero XRD peak for cubic ZnS with Miller indices (220) as determined by Rietveld refinement at 47.6 degrees with an FWHM value of less than 0.5±0.1 degree.

11. The electrode of claim 1, wherein the crystalline cubic zinc sulfide is characterized by a non-zero XRD peak for cubic ZnS with Miller indices (220) as determined by Rietveld refinement at 47.6 degrees with an FWHM value of less than 0.35±0.1 degree.

12. The electrode of claim 1, wherein the crystalline cubic zinc sulfide is characterized by a non-zero XRD peak for cubic ZnS with Miller indices (220) as determined by Rietveld refinement at 47.6 degrees with an FWHM value of less than 0.2±0.1 degree.

13. The electrode of claim 1, wherein the crystalline cubic zinc sulfide is characterized by a non-zero XRD peak for cubic ZnS with Miller indices (311) as determined by Rietveld refinement at 56.4 degrees with an FWHM value of less than 0.6±0.1 degree.

14. The electrode of claim 1, wherein the crystalline cubic zinc sulfide is characterized by a non-zero XRD peak for cubic ZnS with Miller indices (311) as determined by Rietveld refinement at 56.4 degrees with an FWHM value of less than 0.45±0.1 degree.

15. The electrode of claim 1, wherein the crystalline cubic zinc sulfide is characterized by a non-zero XRD peak for cubic ZnS with Miller indices (311) as determined by Rietveld refinement at 56.4 degrees with an FWHM value of less than 0.35±0.1 degree.

16. The electrode of claim 1, wherein the crystalline cubic zinc sulfide is characterized by a non-zero XRD peak for cubic ZnS with Miller indices (200) as determined by Rietveld refinement at 33.1 degrees with an FWHM value of less than 0.6±0.1 degree.

17. The electrode of claim 1, wherein the crystalline cubic zinc sulfide is characterized by a non-zero XRD peak for cubic ZnS with Miller indices (200) as determined by Rietveld refinement at 33.1 degrees with an FWHM value of less than 0.45±0.1 degree.

18. The electrode of claim 1, wherein the crystalline cubic zinc sulfide is characterized by a non-zero XRD peak for cubic ZnS with Miller indices (200) as determined by Rietveld refinement at 33.1 degrees with an FWHM value of less than 0.3±0.1 degree.

19. The electrode of claim 1, wherein the crystalline cubic zinc sulfide is characterized by a non-zero XRD peak for cubic ZnS with Miller indices (200) as determined by Rietveld refinement at 33.1 degrees with an FWHM value of less than 0.2±0.1 degree.

20. The electrode of claim 1, wherein the crystalline cubic zinc sulfide is present in the electrode as particles of between 0.1 micron and 500 micron in size.

21. The electrode of claim 1, wherein the crystalline cubic zinc sulfide is present in an amount of between 0.01% and 20% by weight with respect to weight of the iron active material.

22. An iron electrode battery, comprising:
an iron electrode; and
a sulfide reservoir separate from the iron electrode, the sulfide reservoir comprising crystalline cubic zinc sulfide.

23. The battery of claim 22, wherein the crystalline cubic zinc sulfide has a high degree of crystallinity as measured by at least one metric.

24. The battery of claim 22, wherein at least 50 mass % of the zinc sulfide additive is in the form of cubic zinc sulfide.

25. The battery of claim 24, wherein at least 75 mass % of the zinc sulfide additive is in the form of cubic zinc sulfide.

26. The battery of claim 25, wherein at least 90 mass % of the zinc sulfide additive is in the form of cubic zinc sulfide.

27. The battery of claim 26, wherein at least 95 mass % of the zinc sulfide additive is in the form of cubic zinc sulfide.

28. The battery of claim 22, wherein the crystalline cubic zinc sulfide is characterized by a non-zero x-ray diffraction (XRD) peak at 28.6±0.1 degrees with a full-width at half-maximum (FWHM) value of less than 0.4±0.1 degree.

29. The battery of claim 22, wherein the crystalline cubic zinc sulfide is characterized by a non-zero XRD peak at 47.6±0.1 degrees with an FWHM value of less than 0.5±0.1 degree.

30. The battery of claim 22, wherein the crystalline cubic zinc sulfide is characterized by a non-zero XRD peak at 56.4±0.1 degrees with an FWHM value of less than 0.6±0.1 degree.

31. The battery of claim 22, wherein the crystalline cubic zinc sulfide is present in the electrode as particles of between 0.1 micron and 500 micron in size.

32. The battery of claim 31, wherein the crystalline cubic zinc sulfide is present in an amount of between 0.01% and 20% by weight of the iron active material.

33. The battery of claim 32, wherein the battery is a selected from the group consisting of an iron-air battery, a nickel-iron battery, and an iron-manganese dioxide battery.

34. The battery of claim 33, comprising an electrolyte having a sulfide concentration selected from the range of 0.01±20% mmol/L to 10±20% mmol/L during operation of said battery.

35. A battery electrode, comprising:
an iron electrode body comprising iron active material and a manganese sulfide additive, wherein the manganese sulfide additive comprises crystalline cubic manganese sulfide.

36. The electrode of claim 35, wherein the crystalline cubic manganese sulfide has a high degree of crystallinity as measured by at least one metric.

37. The electrode of claim 35, wherein at least 50 mass % of the manganese sulfide additive is in the form of cubic manganese sulfide.

38. The electrode of claim 37, wherein at least 75 mass % of the manganese sulfide additive is in the form of cubic manganese sulfide.

39. The electrode of claim 38, wherein at least 90 mass % of the manganese sulfide additive is in the form of cubic manganese sulfide.

40. The electrode of claim 39, wherein at least 95 mass % of the manganese sulfide additive is in the form of cubic manganese sulfide.

41. The electrode of claim 35, wherein the crystalline cubic manganese sulfide is present in the electrode as particles of between 0.1 micron and 500 micron in size.

42. The electrode of claim 35, wherein the crystalline cubic manganese sulfide is present in an amount of between 0.01% and 20% by weight of the iron active material.

43. An iron electrode battery, comprising:
an iron electrode and a sulfide reservoir separate from the iron electrode, the sulfide reservoir comprising crystalline cubic manganese sulfide.

44. The battery of claim 43, wherein the crystalline cubic manganese sulfide has a high degree of crystallinity as measured by at least one metric.

45. The battery of claim 43, wherein at least 50 mass % of the manganese sulfide additive is in the form of cubic manganese sulfide.

46. The battery of claim 45, wherein at least 75 mass % of the manganese sulfide additive is in the form of cubic manganese sulfide.

47. The battery of claim 46, wherein at least 90 mass % of the manganese sulfide additive is in the form of cubic manganese sulfide.

48. The battery of claim 47, wherein at least 95 mass % of the manganese sulfide additive is in the form of cubic manganese sulfide.

49. The battery of claim 43, wherein the crystalline cubic manganese sulfide is present in the electrode as crystallites of between 0.1 micron and 500 micron in size.

50. The battery of claim 43, wherein the crystalline cubic manganese sulfide is present in an amount of between 0.01% and 20% by weight of the iron active material.

51. The battery of claim 43, wherein the battery is a member of the group consisting of an iron-air battery, a nickel-iron battery, and an iron-manganese dioxide battery.

52. The battery of claim 43, comprising an electrolyte having a sulfide concentration selected from the range of 0.01±20% mmol/L to 10±20% mmol/L.

53-55. (canceled)

56. The battery of claim 22, wherein the iron electrode comprises less than 1 mass % of any combination of amorphous ZnS, unstructured cubic ZnS, crystalline hexagonal ZnS, amorphous MnS, unstructured cubic MnS, and crystalline hexagonal MnS prior to and/or during operation of the battery.

57. The electrode of claim 1, comprising less than 1 mass % of any combination of amorphous ZnS, unstructured cubic ZnS, crystalline hexagonal ZnS, amorphous MnS, unstructured cubic MnS, and crystalline hexagonal MnS.
